(19) United States
(12) Patent Application Publication
(10) Pub. No.: US 2025/0370208 A1
(43) Pub. Date: Dec. 4, 2025

(54) CABLE SEALING MODULES FOR USE WITH ENCLOSURE CABLE SEALING UNITS

(71) Applicant: CommScope Technologies LLC, Hickory, NC (US)

(72) Inventors: Philippe COENEGRACHT, Hasselt (BE); Olivier C. ROCHE, Schaerbeek (BE); Ine APPELTANS, Herk-de-stad (BE); Barry Wayne ALLEN, Siler City, NC (US); William B. BRYAN, Fuquay-Varina, NC (US); Gary William ADAMS, Holly Springs, NC (US); Kurt VANDENBERGH, Lommel (BE); Joey VERRYTT, Edegem (BE); Laurens Karel G THIELMAN, Leuven (BE); Matthew CAMPSTEYN, Hoeselt (BE); Eddy Luc CAMS, Bilzen (BE); Ronnie Rosa Georges LIEFSOENS, Tessenderlo (BE)

(73) Assignee: CommScope Technologies LLC, Hickory, NC (US)

(21) Appl. No.: 19/108,053

(22) PCT Filed: Aug. 29, 2023
(86) PCT No.: PCT/US2023/073117

§ 371 Date: Feb. 28, 2025

Related U.S. Application Data
(60) Provisional application No. 63/402,005, filed on Aug. 29, 2022.
(60) Provisional application No. 63/579,068, filed on Aug. 28, 2023.

(51) Int. Cl. G02B 6/44

(52) U.S. Cl. CPC G02B 6/44465

(57) ABSTRACT

The present disclosure relates to cable sealing modules adapted to be installed in a cable sealing unit of an enclosure. The cable sealing modules can have containment end wall portions for providing sealant containment.

### CROSS-REFERENCE TO RELATED APPLICATION(S)

This application is being filed on Aug. 29, 2023, as a PCT International application and claims the benefit of and priority to U.S. Provisional Application No. 63/402,005, filed Aug. 29, 2022, and claims the benefit of U.S. Provisional Application No. 63/579,068, filed Aug. 28, 2023, the disclosures of which are hereby incorporated by reference in their entireties.

### TECHNICAL FIELD

The present disclosure relates generally to telecommunications equipment. More particularly, the present disclosure relates to sealed enclosures used in telecommunication systems.

### BACKGROUND

Telecommunications systems typically employ a network of telecommunications cables capable of transmitting large volumes of data and voice signals over relatively long distances. The telecommunications cables can include fiber optic cables, electrical cables, or combinations of electrical and fiber optic cables. A typical telecommunications network also includes a plurality of telecommunications enclosures integrated throughout the network of telecommunications cables. The telecommunications enclosures are adapted to house and protect telecommunications components such as splices, termination panels, power splitters and wavelength division multiplexers. It is often preferred for the telecommunications enclosures to be re-enterable. The term “re-enterable” means that the telecommunications enclosures can be reopened to allow access to the telecommunications components housed therein without requiring the removal and destruction of the telecommunications enclosures. For example, certain telecommunications enclosures can include separate access panels that can be opened to access the interiors of the enclosures, and then closed to re-seal the enclosures. Other telecommunications enclosures take the form of elongated sleeves formed by wrap-around covers or half-shells having longitudinal edges that are joined by clamps or other retainers. Still other telecommunications enclosures include two half-pieces that are joined together through clamps, wedges or other structures.

Telecommunications enclosures are typically sealed to inhibit the intrusion of moisture or other contaminants. Pressurized gel-type seals have been used to effectively seal the locations where telecommunications cables enter and exit telecommunications enclosures. Example pressurized gel-type seals are disclosed by European patent Nos. EP 0442941B1 and EP 0587616B1 as well as PCT International Publication Nos. WO 2014/005919; WO 2014/005917; and WO 2014/005916.

### SUMMARY

Aspects of the present disclosure relate to cable sealing modules adapted to be installed in a cable sealing unit for an enclosure.

In one example, a cable sealing module includes a sealant containment wall having end wall portions that meet at a mechanical interface having central and opposite end overlap structures that provide central and end stabilization with respect to the end wall portions.

In another example, a cable sealing module has first and second cable pass-through openings that are substantially different in size. In one example, the larger opening corresponds to a port that is sealed by a plug when not occupied by a cable, and the smaller opening corresponds to a port that is sealed without the use of a plug.

In another example, a cable sealing module includes a sealant containment wall having end wall portions that meet at an overlapping mechanical interface and are also connected by a threaded fastener.

In another example, a cable sealing module includes sealant containment provided by linear combs.

In another example, a cable sealing module includes sealant containment provided by elastomeric resilient sheets that are formed with integrated retention ribs

In another example, a cable sealing module includes sealant containment provided by a linear arrangement of clips.

In another example, a cable sealing module including a first removebale sealant portion carried by an elongate removeable container that extends along a cable pass-through orientation of the module, and a second removeable sealant portion that extends transversely relative to the cable pass-through orientation.

Another example of the present disclosure relates to a cable sealing device including a sealing module including sealant contained axially between first and second sealant containment walls. The sealing module includes first and second bodies that join together to form the cable sealing module and that are separable to facilitate routing a cable between the first and second bodies. The first body includes first wall portions of the first and second sealant containment walls and a first sealant portion of the sealant. The first sealant portion is secured axially between the first wall portions. The second body includes second wall portions of the first and second sealant containment walls and a second sealant portion of the sealant. The second sealant portion is secured axially between the second wall portions. The first and second sealant containment walls each include a reinforcing structure and a sealant containment structure that are secured axially together. The reinforcing structures each include first reinforcing portions corresponding to the first wall portions and second reinforcing portions corresponding the second wall portions. The sealant containment structures each include first sealant containment portions corresponding to the first wall portions and second sealant containment portions corresponding to the second wall portions. The reinforcing structure and the sealant containment structure respectively have different first and second material compositions with the first material composition of the reinforcing structures being harder than the second material composition of the sealant containment structures. The sealant containment structures are secured axially between the sealant and the reinforcing structures of the first and second containment walls. The sealant includes a third material composition that is softer than the second material composition.

Another example of the present disclosure relates to a cable sealing device including a sealing module including sealant contained axially between sealant containment walls. The sealing module includes first and second bodies that join together to form the cable sealing module and that are separable to facilitate routing a cable between the first and second bodies. The first body includes first wall portions of the sealant containment walls and a first sealant portion of the sealant. The first sealant portion is secured axially between the first wall portions. The second body includes second wall portions of the sealant containment walls and a second sealant portion of the sealant. The second sealant portion is secured axially between the second wall portions. The first and second wall portions define a central guide structure that aligns with a region between two cable pass-through locations of the sealing module for guiding assembly of the first and second bodies together. The central guide structure includes a guide rail that fits within a guide channel.

Another example of the present disclosure relates to a cable sealing device including a sealing module including sealant axially contained between sealant containment walls. The sealing module includes first and second bodies that join together to form the cable sealing module and that are separable to facilitate routing a cable between the first and second bodies. The first body includes first wall portions of the sealant containment walls and a first sealant portion of the sealant. The first sealant portion is secured axially between the first wall portions. The second body includes second wall portions of the sealant containment walls and a second sealant portion of the sealant. The second sealant portion is secured axially between the second wall portions. The first and second sealant portions have first sides that oppose each other when the sealing module is assembled. The sealing module includes a first open-sided trough embedded in the first sealant portion adjacent the first side. The first open-sided trough has a trough length that extends at least 75 percent of a height of the first sealant portion. The first open-sided trough is filled with sealant and is positioned to correspond to a cable pass-through location that extends through the height of the sealing module. The first open-sided trough includes opposite first and second longitudinal edges that extend along the trough length. The first sealant portion has first and second rows of tear openings at the first side which are positioned along the first and second longitudinal edges for facilitating tearing the open-sided trough from the first sealant portion.

Another example of the present disclosure relates to a cable sealing device including a sealing module including sealant axially contained between sealant containment walls. The sealing module includes first and second bodies that join together to form the cable sealing module and that are separable to facilitate routing a cable between the first and second bodies. The first body includes first wall portions of the sealant containment walls and a first sealant portion of the sealant. The first sealant portion is secured axially between the first wall portions. The second body includes second wall portions of the sealant containment walls and a second sealant portion of the sealant. The second sealant portion is secured axially between the second wall portions. The first and second wall portions each define at least one curved notch that aligns with an axial cable pass-through location of the sealing module that is defined between the first and second bodies. The curved notches of the first and second wall portions are defined by sealant containment fingers that extend into the sealant and form a truncated, tapered structure. Tips of the sealant containment fingers define a first inner cross-dimension. The sealant defines a pass-through opening that extends along the cable-pass-through location. The sealant is stepped adjacent the tips of the sealant containment fingers such that a second inner cross-dimension defined by the pass-through opening is larger than the first inner cross-dimension.

Another example of the present disclosure relates to a cable sealing device including a sealing module including sealant axially contained between sealant containment walls. The sealing module includes first and second bodies that join together to form the cable sealing module and that are separable to facilitate routing a cable between the first and second bodies. The first body includes first wall portions of the sealant containment walls and a first sealant portion of the sealant. The first sealant portion is secured axially between the first wall portions. The second body includes second wall portions of the sealant containment walls and a second sealant portion of the sealant. The second sealant portion is secured axially between the second wall portions. The sealing module further includes a cable locator that projects outwardly from one of the sealant containment walls and defines cable pockets that align with cable pass-through locations of the sealing module.

Another example of the present disclosure relates to a cable sealing device including a sealing module including sealant axially contained between sealant containment walls. The sealing module includes first and second bodies that join together to form the cable sealing module and that are separable to facilitate routing a cable between the first and second bodies. The first body includes first wall portions of the sealant containment walls and a first sealant portion of the sealant. The first sealant portion is secured axially between the first wall portions. The second body includes second wall portions of the sealant containment walls and a second sealant portion of the sealant. The second sealant portion is secured axially between the second wall portions. The sealant containment walls define cable openings corresponding to cable pass-through locations defined though the sealing module. The sealant containment walls include pairs of first and second fins corresponding to at least some of the cable pass-through locations. The first and second fins have base ends unitary with the sealant containment walls and free ends embedded in the sealant. The first and second fins of each pair converge as the first and second fins extend into the sealant. The first and second fins are adapted for providing sealant containment when sealing a flat cable and are adapted to oppose major sides of the flat cable when the cable is routed through the sealing module. Each of the cable openings does not include more than two of the fins. The first and second fins are configured to resiliently flex apart to accommodate a cable between the first and second fins when the cable is routed through a corresponding one of the cable pass-through locations.

Another example of the present disclosure relates to an enclosure including a housing defining an opening and a cable sealing unit that fits in the opening of the housing. The cable sealing unit includes sealing gel positioned between inner and outer pressurization structures of an actuator configured for pressurizing the sealing gel between the inner and outer pressurization structures once the cable sealing unit has been inserted in the housing. The housing has an interior surface defining the opening. The sealing gel seals against the interior surface when the sealing gel is pressurized between the inner and outer pressurization structure while the cable sealing unit is located within the opening of the housing. The cable sealing unit includes radial seal structures at the inner and outer pressurization structures that project radially outwardly further than the sealing gel prior to pressurization of the sealing gel. The radial seal structures are elastomeric and form inner and outer radial seals with respect to the interior surface of the housing when the cable sealing unit is initially inserted into the opening and prior to pressurization of the sealing gel. The sealing gel is contained between the inner and outer radial seals when the sealing gel is pressurized between the inner and outer pressurizations structures while the cable sealing unit is within the opening of the housing. The radial seal structures have a material composition that is harder than a material composition of the sealing gel.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventions and inventive concepts upon which the embodiments disclosed herein are based.

### BRIEF DESCRIPTION OF THE DRAWINGS

FIG. 1 depicts an enclosure (e.g., a telecommunications enclosure) in accordance with the principles of the present disclosure;

FIG. 2 is an exploded view of the enclosure of FIG. 1;

FIG. 3 is a perspective view of an actuator assembly of the enclosure of FIG. 1;

FIG. 4 depicts the actuator assembly of FIG. 3 with sealant modules exploded from the actuator assembly;

FIG. 5 is a perspective view of a first example sealing module usable with the actuator assembly of FIG. 3;

FIG. 6 is an exploded view of the sealing module of FIG. 5;

FIG. 7 is another exploded view of the sealing module of FIG. 5;

FIG. 8 is a perspective view of a second example sealing module usable with the actuator assembly of FIG. 3;

FIG. 9 is an exploded view of the sealing module of FIG. 8;

FIG. 10 is another exploded view of the sealing module of FIG. 8;

FIG. 11 is a perspective view of a third example sealing module usable with the actuator assembly of FIG. 3;

FIG. 12 is an exploded view of the sealing module of FIG. 11;

FIG. 13 is another exploded view of the sealing module of FIG. 11;

FIG. 14 is a perspective view of one half of the sealing module of FIG. 11 with a portion of the sealant removed to expose inner removeable retaining cups;

FIG. 15 is a perspective view of one of the removeable retaining cups of the sealing module of FIG. 11;

FIG. 16 is a perspective view of a removable volume of sealant of the sealing module of FIG. 11 that is partially retained in the removeable retaining cups;

FIG. 17 is another perspective view of the removeable volume of sealant of FIG. 16;

FIG. 18 is a perspective view of an elastomeric sealant containment barrier used in the sealing module of FIG. 11;

FIG. 19 is another perspective view of the elastomeric sealant containment barrier of FIG. 18;

FIG. 20 is a perspective view of a fourth example sealing module usable with the actuator assembly of FIG. 3;

FIG. 21 is an exploded view of the sealing module of FIG. 20;

FIG. 22 is another exploded view of the sealing module of FIG. 20;

FIG. 23 is a perspective view of one half of the sealing module of FIG. 20;

FIG. 24 depicts a sealant containment device of the sealing module of

FIG. 20 installed within a containment wall of the sealing module and with the sealant removed;

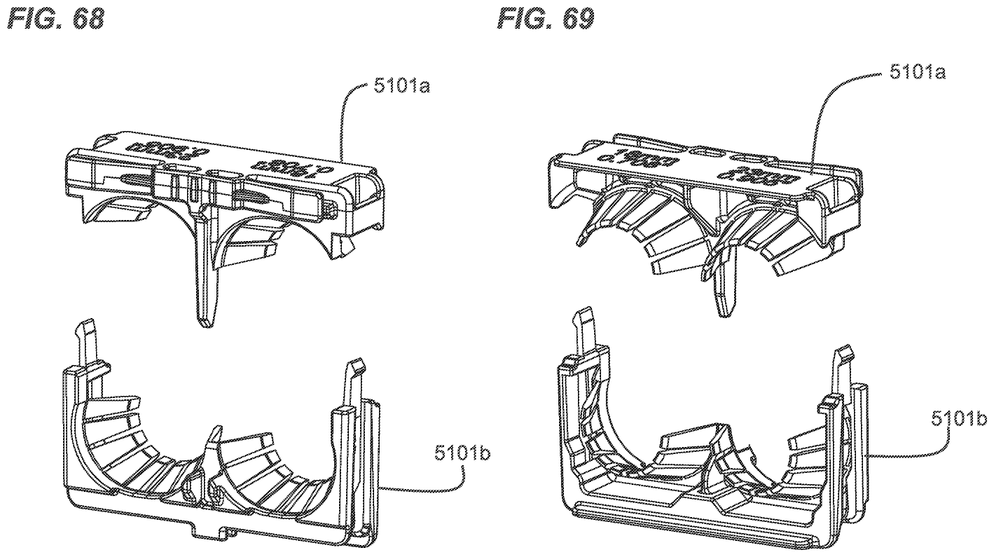

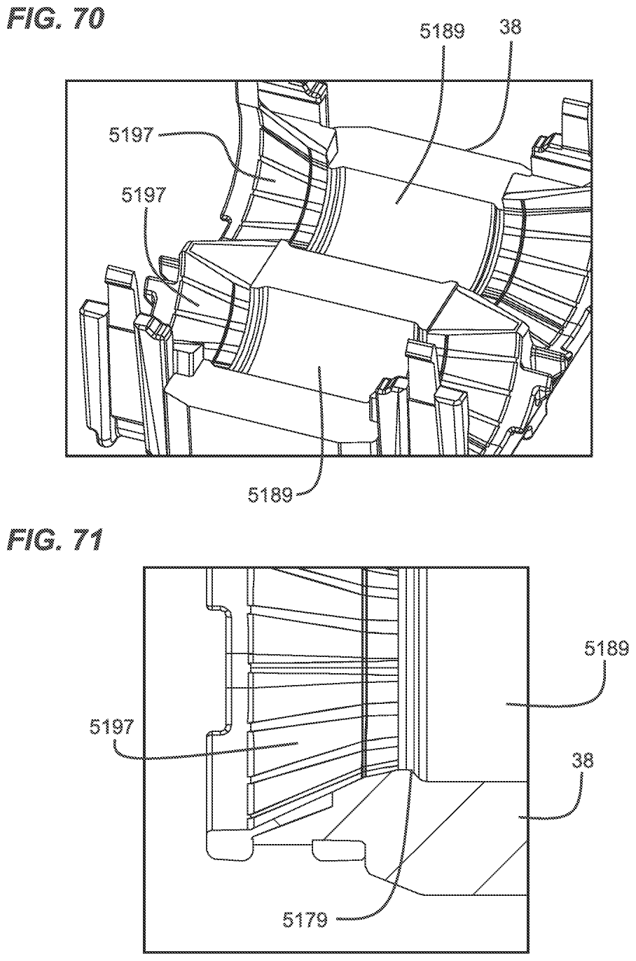

FIG. 25 is a perspective view of the sealant containment device of FIG. 24;

FIG. 26 is a top view of the sealant containment device of FIG. 25;

FIG. 27 is a front view of the sealant containment device of FIG. 25;

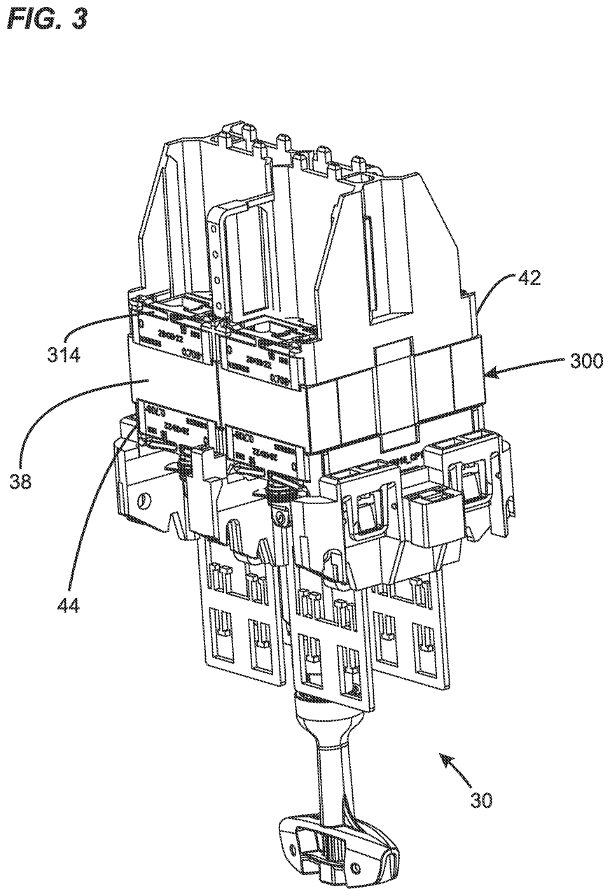

FIG. 28 is a perspective view of a fifth example sealing module usable with the actuator assembly of FIG. 3;

FIG. 29 is an exploded view of the sealing module of FIG. 28;

FIG. 30 is another exploded view of the sealing module of FIG. 28;

FIG. 31 is an exploded end view of the sealing module of FIG. 28 with the sealant removed;

FIG. 32 is an exploded perspective view of the sealing module of FIG. 28 with the sealant removed;

FIG. 33 is another exploded perspective view of the sealing module of FIG. 28 with the sealant removed;

FIG. 34 is a perspective view of a sixth example sealing module usable with the actuator assembly of FIG. 3;

FIG. 35 is a perspective view of the sealing module of FIG. 34 with first and second bodies of the sealing module separated from each other;

FIG. 36 is an exploded view of the sealing module of FIG. 35;

FIG. 37 shows one side of a sealant containment wall of the sealing module of FIG. 34 with two parts of the sealant containment wall separated from each other;

FIG. 38 is a perspective view of one side of the sealant containment wall of FIG. 37;

FIG. 39 is a perspective view of an opposite side of the sealant containment wall of FIG. 39;

FIG. 40 is a perspective view of a removeable sealant container of the sealing module of FIG. 34;

FIG. 41 is a perspective view of a volume of sealant of the sealing module of FIG. 34;

FIG. 42 is a perspective view of a first side of a half-portion of the volume of sealant of FIG. 41;

FIG. 43 is a perspective view of an opposite second side of the half-portion of sealant of FIG. 42;

FIG. 44 is another perspective view of the second side of the half-portion of sealant of FIG. 42;

FIG. 45 is another perspective view of the first side of the half-portion of sealant of FIG. 42;

FIG. 46 is an exploded view of a seventh example sealing module usable with the actuator assembly of FIG. 3;

FIG. 47 is an exploded view of an eighth example sealing module usable with the actuator assembly of FIG. 3;

FIG. 48 is a perspective view of a nineth example sealing module usable with the actuator assembly of FIG. 3;

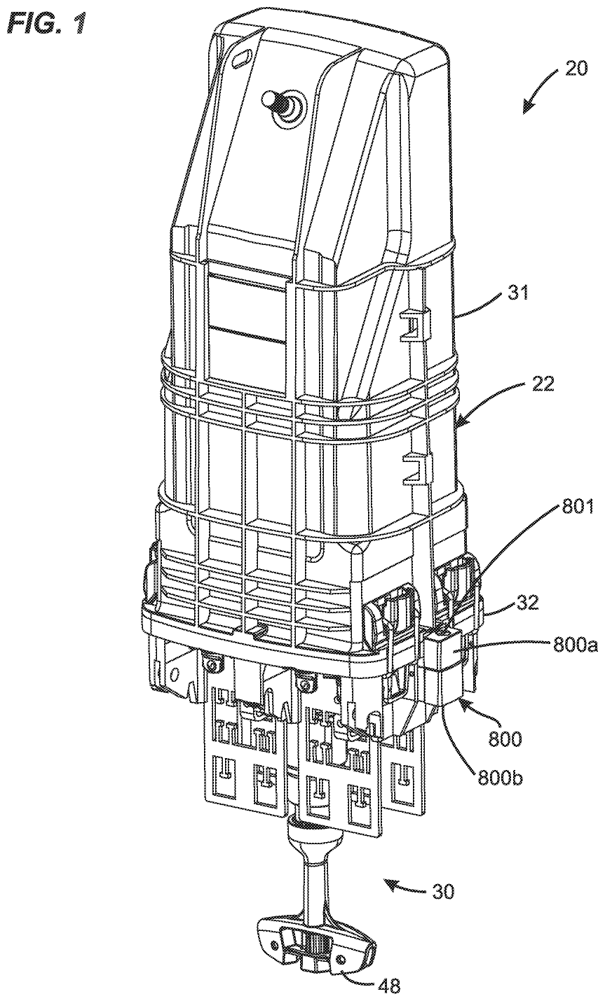

FIG. 49 is a schematic depiction of the enclosure of FIGS. 1-4 with the sealing modules of FIG. 48 loaded between inner and outer pressurization frames of the actuator to populate the sealing unit with sealing modules, the sealing unit is shown outside the housing of the enclosure;

FIG. 50 is a schematic depiction of the enclosure of FIG. 49 with the sealing unit inserted into the housing of the enclosure, the depicted sealing unit has not yet been pressurized by the actuator;

FIG. 51 is a schematic depiction of the enclosure of FIG. 49 with the sealing unit inserted into the housing of the enclosure and the sealant pressurized by the actuator;

FIG. 52 is a perspective view of a tenth example sealing module usable with the actuator assembly of FIG. 3;

FIG. 53 is a perspective view of the sealing module of FIG. 52 with first and second bodies of the sealing module separated from each other;

FIG. 54 is an exploded view of the sealing module of FIG. 53;

FIG. 55 shows one side of a first sealant containment wall of the sealing module of FIG. 52 with two parts of the sealant containment wall separated from each other;

FIG. 56 is a perspective view of a first side of the upper part of the first sealant containment wall of FIG. 55;

FIG. 57 is a perspective view of an opposite second side of sealing wall part of FIG. 56;

FIG. 58 is a perspective view of a first side of the lower part of the first sealant containment wall of FIG. 55;

FIG. 59 is a perspective view of an opposite second side of the sealing wall part of FIG. 58;

FIG. 60 is a perspective view of a first side of a lower part of the second sealant containment wall of the sealing muddle of FIG. 52;

FIG. 61 is a perspective view of an opposite second side of the sealing wall part of FIG. 60;

FIG. 62 is a perspective view of the second body of the sealing module of FIG. 52;

FIG. 63 is another perspective view of the second body of the sealing module of FIG. 52;

FIG. 64 is a perspective view of an eleventh example sealing module usable with the actuator assembly of FIG. 3;

FIG. 65 is a perspective view of the sealing module of FIG. 64 with first and second bodies of the sealing module separated from each other;

FIG. 66 is an exploded view of the sealing module of FIG. 65;

FIG. 67 shows a first side of a sealant containment wall of the sealing module of FIG. 64 with two parts of the sealant containment wall separated from each other;

FIG. 68 is a perspective view showing the first side of the sealant containment wall of FIG. 67;

FIG. 69 is a perspective view showing an opposite second side of the sealant containment wall of FIG. 68;

FIG. 70 is a perspective view depicting portions of the second body of the sealing module of FIG. 64; and

FIG. 71 is a cross-sectional view through a portion of the second body of the sealing module of FIG. 64 showing an internal step defined within a pass-through opening of the sealing module.

### DETAILED DESCRIPTION

Aspects of the present disclosure relate to sealing modules used with an actuator system to seal an enclosure opening through which one or more cables can be routed. The actuator system can include pressurization structures (e.g., walls, plates, parts, components, elements, structures, etc.) between which sealant can be axially contained and pressurized. In certain examples, each of the pressurization structures can include one or more parts. In certain examples, a pressurization structure can include a frame structure and sealant containment walls coupled to the frame structure. The sealant containment walls can be integrated as part of sealing modules and can function to provide containment of sealant of the sealing modules. The actuator system can include a spring for biasing the pressurization structures together to pressurize the sealant.

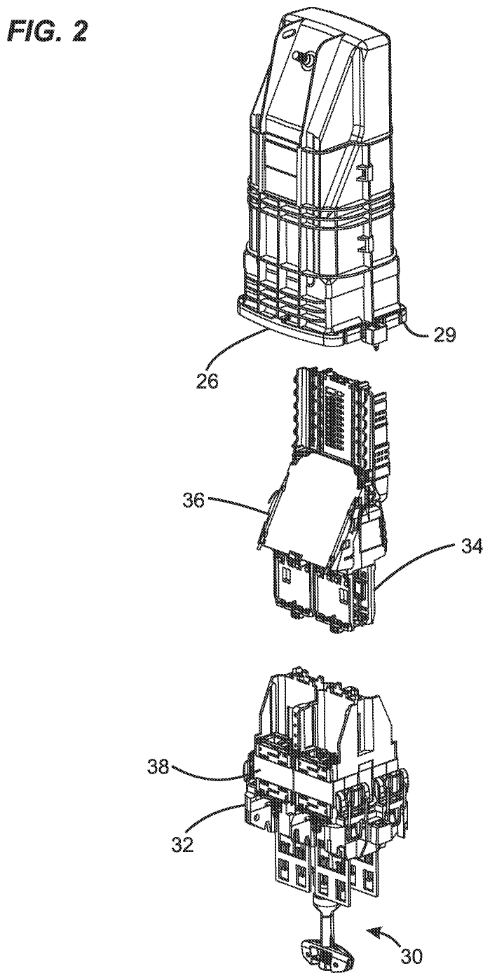

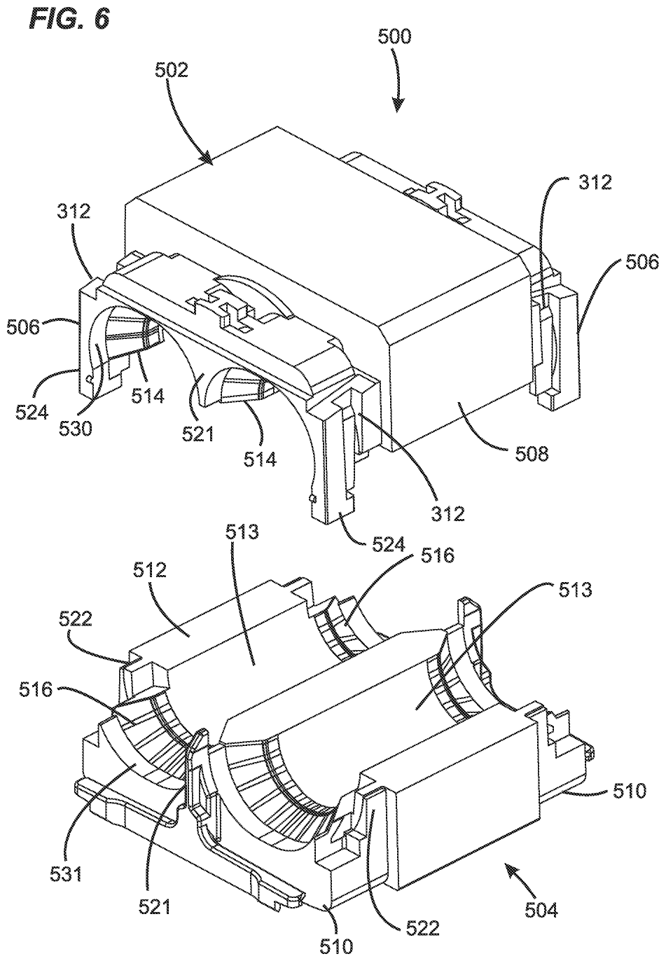

FIG. 1 shows an enclosure 20 (e.g., a telecommunications enclosure) in accordance with the principles of the present disclosure. The enclosure 20 includes a housing 22 having an opening 26 into an interior of the housing 22. The enclosure includes a cable sealing unit 30 (see FIGS. 2, 4 and 6) that mounts within the opening 26 for sealing about one or more cables desired to be routed into the interior of the housing 22 through the opening 26. The cable sealing unit 30 can also provide peripheral sealing with the housing 22 about a perimeter of the opening 26. In the example shown, the housing 22 includes a cover 31 (e.g., a dome style cover) defining the opening 26 at one end 29, and a base 32 that mounts to the end 29 of the cover 31. In certain examples, the base 32 can be detachably secured to the cover 31 by a mechanical fastening arrangement that can include latches, clamps, fasteners, or the like. The cable sealing unit 30 can be retained in the opening 26 by the base 32. A frame 34 (see FIG. 2) supporting fiber optic components 36 (e.g., optical splice trays, optical splitter trays, etc.) can be carried with the sealing unit 30. In one example, cable sealing unit 30 includes sealant 38 (e.g., a sealant arrangement, a volume of sealant that may be formed by one or more sections or blocks of sealant (e.g., sealing modules), etc.) defining a plurality of cable pass-through locations (e.g., ports, interfaces between adjacent sections of sealant, etc.). When pressurized, the sealant 38 is configured for providing seals about structures (e.g., cables, plugs, etc.) routed though the pass-through locations of the sealant 38 and is also configured for providing a peripheral seal between the housing 22 (e.g., the interior of the cover 31) and the cable sealing unit 30 about the boundary (e.g., perimeter, profile, etc.) of the opening 26.

A removeable lock 800 can be provided between the base 32 and the cover 31 in addition to latches. The lock can include locking components 800a, 800b that respectively removeably attach to the cover 31 and the base 32. The components 800a, 800b can house a turnable fastener 801 for locking the components 800a, 800b together and thus locking the cover 31 and the base 32 together. A special tool can be required to turn the turnable fastener 801 thus making it more difficult for unauthorized individuals to open the enclosure. The locking components are adapted to engage (e, hook, interlock) with the cover 31 and the base 32 with such interlocking features not being disengagable from the cover 31 and the base 32 when the locking components 800a, 800b are fastened together by the turnable fastener 801. When the turnable fastener is turned to a release position, the cover 31 can be removed from the base 32. Additionally, with the locking components 800a, 800b unlocked, the locking components 800a, 800b can be detached from the cover 31 and the base 32 if additional locking is not desired.

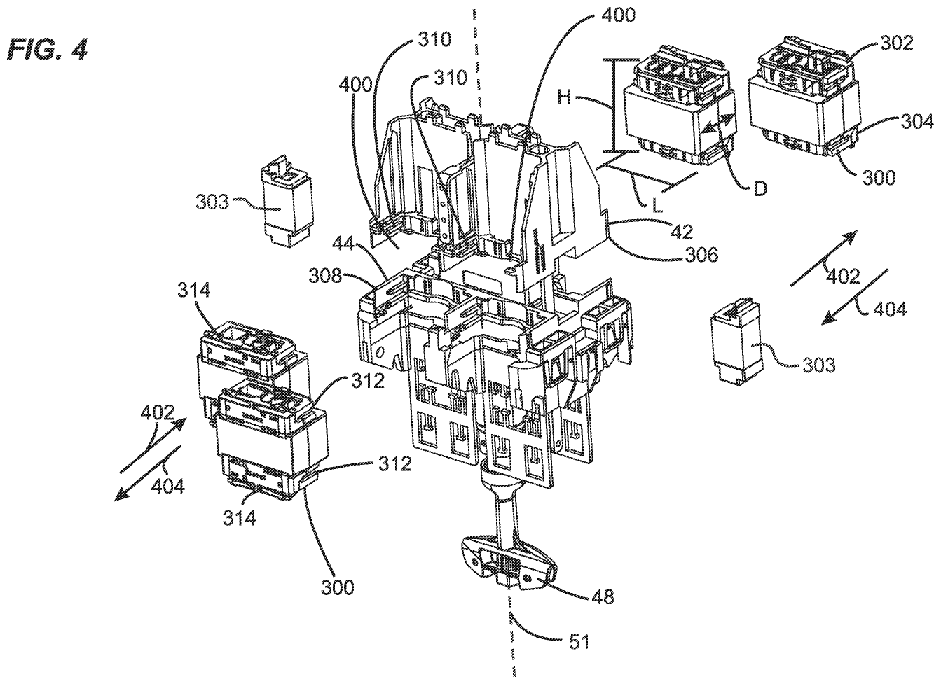

The cable sealing unit 30 includes an actuator arrangement for pressurizing the sealant 38 within the opening 26 once cables have been routed through the sealant during installation of the enclosure 20 in the field. In one example, referring to FIG. 4, the actuator arrangement includes inner and outer pressurization structures 42, 44 between which the sealant 38 is pressurized. The actuator arrangement can include a threaded drive system that drives relative movement of the pressurization structures 42, 44 to pressurize the sealant 38. Torque for driving the threaded drive system can be provided by a torque application interface such as a handle 48. The base 32 can retain the pressurization structures 42, 44 within the housing 22 and one or both of the pressurization structures 42, 44 can be axially moveable relative to the base 32. In other examples, the outer pressurization structure 44 can be integrated with the base. A spring can be incorporated into the actuation arrangement for applying pressurization load. Example actuator arrangements are disclosed by PCT International Publication Nos. WO2014/005916 and WO2023/130092, which are hereby incorporated by reference in their entireties.

The sealant is pressurized between the inner and outer sealant pressurization structure 42, 44 when the inner and outer pressurization structures 42, 44 are forced toward each other by rotating the handle 48 in a first rotational direction and the sealant 38 is de-pressurized when the inner and outer pressurization structures 42, 44 are moved away from each other by rotating the handle 48 in a second rotational direction opposite form the first rotational direction. As used herein an axial direction or orientation is in an orientation along an axis 52 of the actuator arrangement.

Referring to FIG. 4, the sealant 38 is provided as part of sealing modules 300 that removably mount between the inner and outer pressurization structures 42, 44.

The sealing modules 300 each include a volume of sealant 38 positioned axially between inner and outer sealant containment walls 302, 304. The inner pressurization structure 42 includes an inner pressurization frame 306. The outer pressurization structure 44 includes an outer pressurization frame 308. The sealing modules 300 mount between the inner and outer pressurization frames 306, 308. When the sealing modules 300 are mounted between the inner and outer pressurization frames 306, 308, the inner sealant containment walls 302 mechanically engage (e.g., interlock, intermate, etc.) with the inner pressurization frame 306 and the outer sealant containment walls 304 mechanically engage with the outer pressurization frame 308 such that axial load is transferable between the pressurization frames 306, 308 and their respective containment walls 302, 304 to provide axial compression/pressurization of the sealant of the modules 300 during an actuation step and to provide axial tensioning/depressurization during a de-actuation step. The inner pressurization structure 42 includes the combination of the inner pressurization frame 306 and the inner containment walls 302 while the outer pressurization structure 44 includes the combination of the outer pressurization frame 308 and the outer containment walls 304. In the depicted example, mechanical engagement between the containment walls 302, 304 and the pressurization frames 306, 308 is provided by rails 310 that fit within slots 312 when the sealing modules 300 are slid between the inner and outer pressurization frames 306, 308. Central locking members 307 can also engage with receiving structures of the inner and outer pressurization frames 306, 306 to assist in the transfer of axial compressive and tensile loading to the sealing modules 300. The inner and outer containment walls 302, 304 include resilient sealing module latch structures 314 that latch with respect to the inner and outer pressurization frames 306, 308 to retain the sealing modules 300 in fully inserted positions between the inner and outer pressurization frames 306, 308. Each of the modules 300 can include two or more module parts/bodies that can be separated to facilitate routing cables through the modules 300 with the cables sealed between opposing sealant portions of the modules after assembly. End sealing modules 303 can be provided at opposite ends of the sealing arrangement at locations between the rows of sealing modules 300. The end sealing modules 303 can be adapted for sealing a ground wire or bar routed into the interior of the enclosure. In the depicted example, the end sealing modules 303 cooperate with the cable sealing modules 300 to form a continuous loop or ring of sealant that surrounds a central axis of the cable sealing unit 30.

Referring to FIG. 4, the sealing modules 300 are insertable into and removeable from mounting locations 400 defined by the inner and outer pressurization frames 306, 308. The sealing modules 300 are insertable into the mounting locations 400 in laterally inward insertion directions 402 and are removeable from the mounting locations 400 in laterally outward removable directions 404. The insertion and removal directions 402, 404 are perpendicular with respect to the axial direction of the enclosure. When the sealing modules 300 are loaded in the mounting locations 400, the sealing module latches 314 are located at exterior lateral sides of the sealing modules 300 so as to be readily accessible. In certain examples, the sealing modules 300 can have a push-to-engage configuration in which the action of pushing the sealing modules laterally into the mounting locations automatically causes the latches to resiliently flex and snap-back to a retaining position in which interference between the pressurization frames and the latches prevent the sealing modules from being unintentionally displaced from their corresponding mounting locations 400. By manually flexing the latches to non-retaining positions relative to the pressurization structures, the modules 300 can be manually removed from the mounting locations 400.

The sealing modules 300 can include lengths L, depths D and heights H. When the sealing modules 300 are mounted at the mounting locations 400, the heights H extend in the axial orientation of the enclosure and the depths D extend in the lateral orientation. The length L extends between opposite ends 301 of the sealing module 300 and is oriented perpendicular with respect to the depth D and the height H. It will be appreciated that a variety of different modules 300 having different configurations suitable for different cable sizes and types can be used with the actuator assembly. Depending upon user preference and the type of cables intended to be sealed, different cable sealing modules can be mixed and matched within the actuator assembly. In some cases, all of the sealing module used at a given time within the actuator assembly may have the same configuration. In other cases, one or more of the cable sealing modules used at the same time within a given actuator assembly can have different configurations but can work to together to provide cable and enclosure sealing. Thus, any of the types of sealing modules disclosed herein can be used alone to fill an actuator assembly, or can be mixed with other types of the sealing modules to fill an actuator assembly.

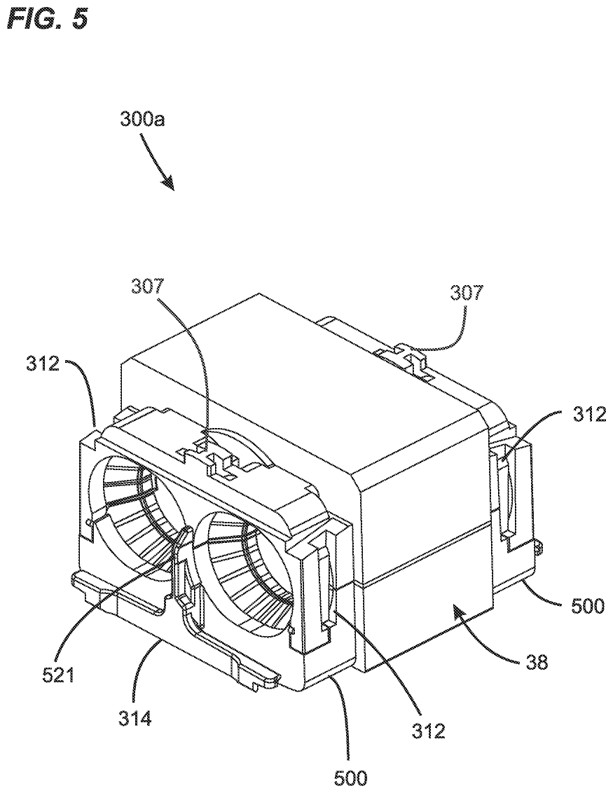

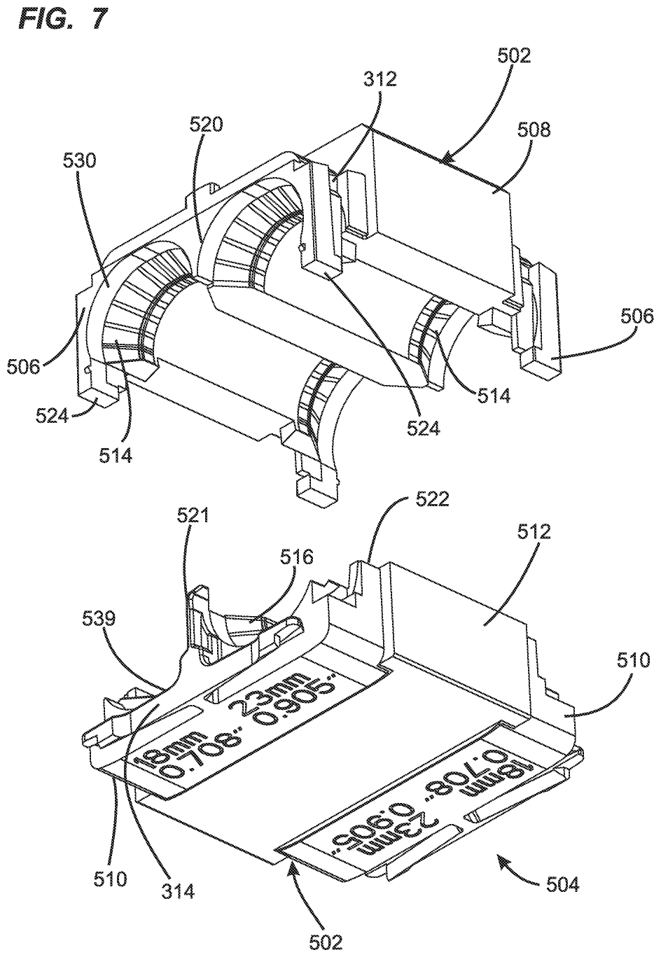

FIGS. 5-7 depict a first sealing module 300a adapted for use with the enclosure 20 and configured to be mounted between the inner and outer pressurization frames 306, 308 of the actuator arrangement. The sealing module 300a includes sealant 38 contained between sealant containment walls 500. The sealing module 300a includes a first body 502 and a second body 504 that mate together to form the sealing module 300a and that are separable to facilitate loading cables into the sealing module 300a. The first body 502 includes first wall portions 506 of the sealant containment walls 500 and a first sealant portion 508 of the sealant 38. The first sealant portion 508 is secured (e.g., adhered) axially between the first wall portions 506. The second body 504 includes second wall portions 510 of the sealant containment walls 500 and a second sealant portion 512 of the sealant 38. The second sealant portion 512 is secured (e.g., adhered) axially between the second wall portions 510. The first and second sealant portions 508, 512 cooperate to define two cable ports 513 that extend axially between the containment walls 500. The first and second wall portions 506, 510 each include sets of fingers 514, 516 at least partially embedded in the corresponding first and second sealant portions 508, 512. The fingers 514, 516 cooperate to define truncated conical finger barriers that extend into the ends of the cable ports 513. The fingers 514, 516 can flex radially to accommodate cables having different diameters. The first and second wall portions 506, 510 also respectively include partial cable openings 530, 531 that cooperate to define cable openings 532 that align with the cable ports 513 when the module 300a is assembled. The cable ports 513 can be filled with plugs when not occupied by cables.

The slots 312 for receiving the rails 310 of the pressurization frames 306, 308 are defined primarily by the first wall portions 506. The latches 314 are provided on the second wall portions 510. The first and second wall portions 506, 510 meet at a mechanical interface that allows axial load to be transferred in both directions (axially inward and axially outward) between the first and second wall portions 506, 510. The interface can be provided by selected overlapping structures of the wall portions, mating structures of the wall portions, nested portions of the wall portions, and the like. In the depicted example, an overlapped and nested configuration is used. For example, central regions 520 of the first wall portions 506 are positioned between central arms 521 of the second wall portions 510 and the sealant 38 in an overlapped configuration, while end sections 522 of the second wall portions 510 are positioned between end arms 524 of the first wall portions 506 and the sealant 38 in an overlapped configuration. The central regions 520 and central arms 521 are aligned between the two cable ports 513. The overlapped configuration provide 3-location support (e.g., at the middle and both ends) that prevents tilting between the first and second wall portions 506, 510.

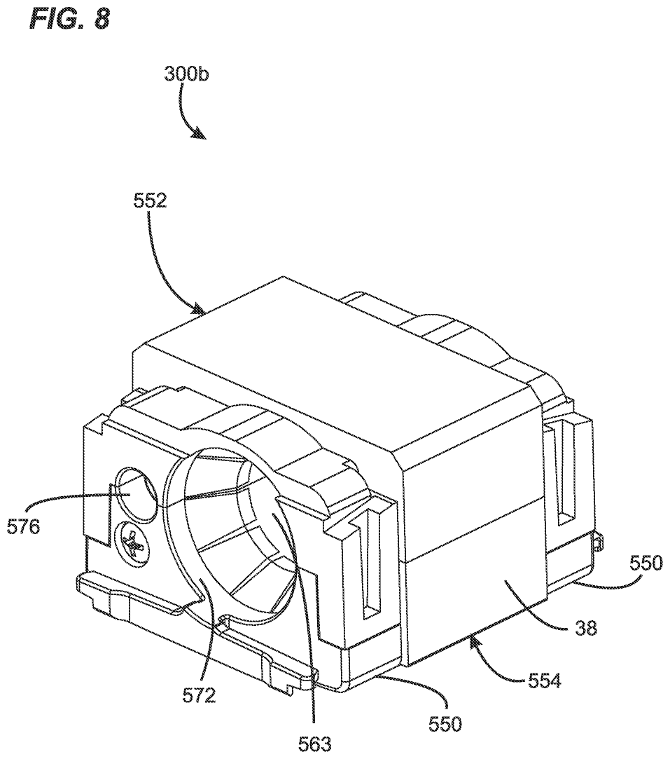

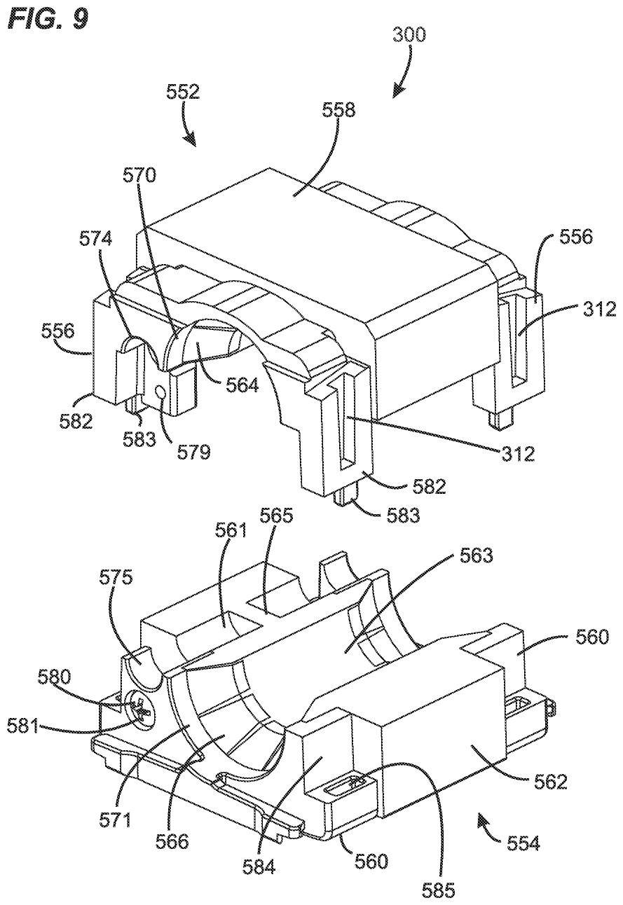

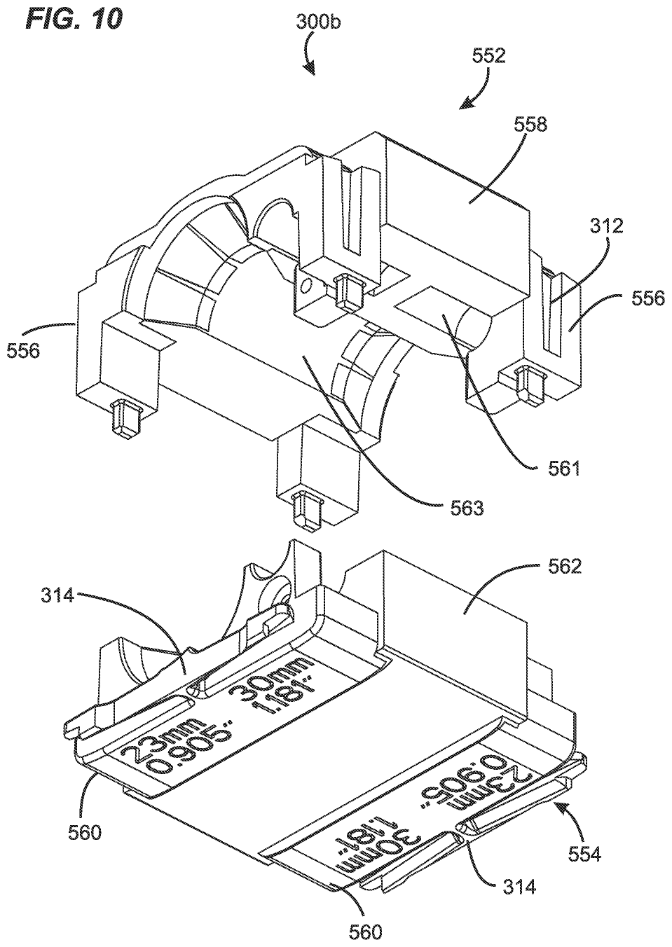

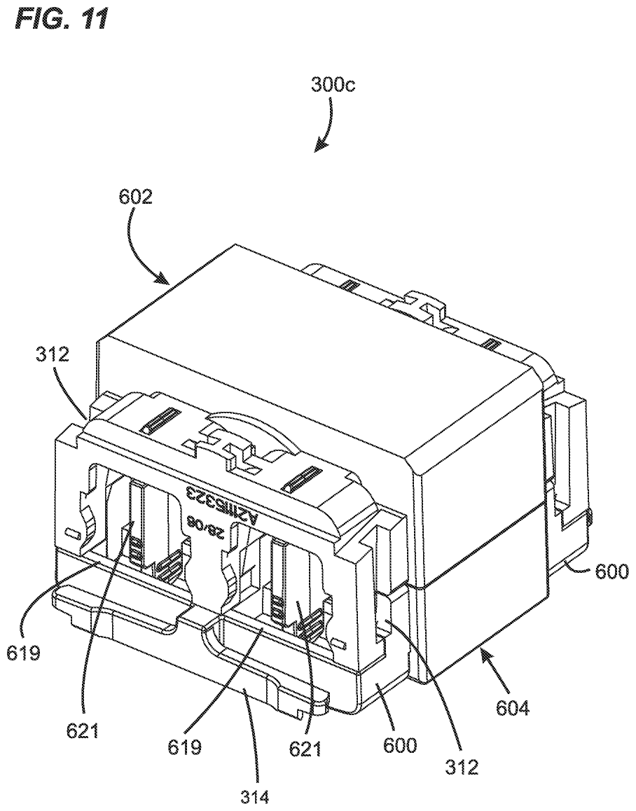

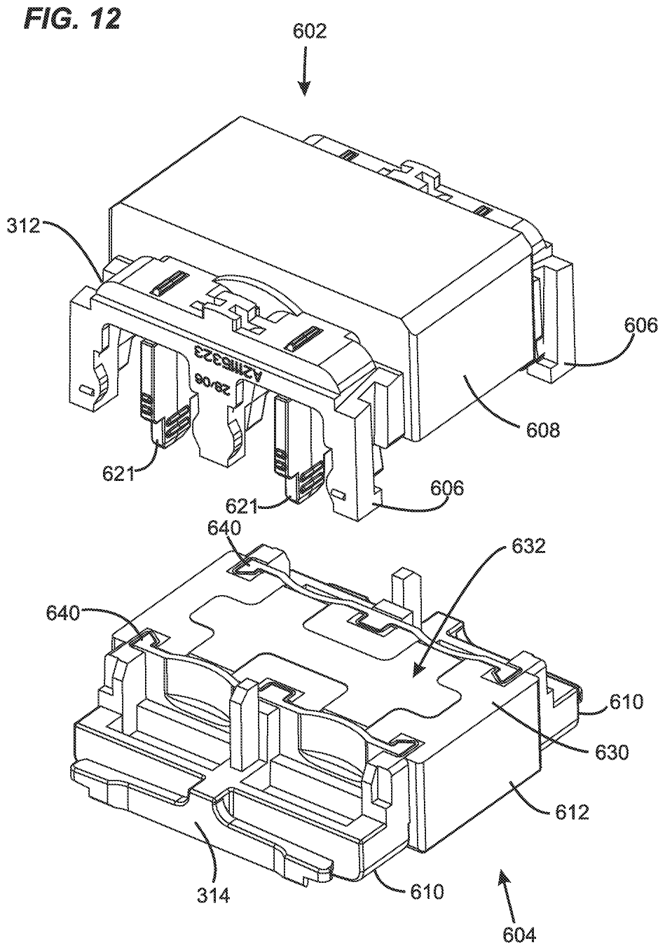

FIGS. 8-10 depict a second sealing module 300b adapted for use with the enclosure 20 and configured to be mounted between the inner and outer pressurization frames 306, 308 of the actuator arrangement. The sealing module 300b includes sealant 38 contained between sealant containment walls 550. The sealing module 300b includes a first body 552 and a second body 554 that mate together to form the sealing module 300b and that are separable to facilitate loading a cable into the sealing module 300b. The sealing module 300b can be adapted for sealing a cable such as a toning cable which can include a larger fiber optic cable portion and a smaller toning wire portion. The module 300b can also seal separate cables such as a larger cable and a smaller cable.

The first body 552 includes first wall portions 556 of the sealant containment walls 550 and a first sealant portion 558 of the sealant 38. The first sealant portion 558 is secured (e.g., adhered) axially between the first wall portions 556. The second body 554 includes second wall portions 560 of the sealant containment walls 550 and a second sealant portion 562 of the sealant 38. The second sealant portion 552 is secured (e.g., adhered) axially between the second wall portions 560. The first and second sealant portions 558, 562 cooperate to define two cable ports 561, 563 that extend axially between the containment walls 550. The cable port 561 is smaller in size than the cable port 563 and includes a central section 565 for blocking the port 561 when not occupied by a cable thereby eliminating the need for a plug. Cable port 563 can be filled with a plug when not occupied by a cable. In one example, cable port 563 can accommodate a cable having a cross-dimension (e.g., outer diameter) at least 2.5 or 3 times as large as the maximum cross-dimension of a cable that can be routed through the cable port 561. The first and second wall portions 556, 560 each include a set of fingers 564, 566 at least partially embedded in the corresponding first and second sealant portions 558, 562. The fingers 564, 566 cooperate to define truncated conical finger barriers that extend into the ends of the cable port 563. The fingers 564, 566 can flex radially to accommodate cables having different diameters. The first and second wall portions 556, 560 also respectively include first partial cable openings 570, 571 that cooperate to define cable openings 572 that align with the cable port 563 when the module 300a is assembled. The first and second wall portions 556, 560 also respectively include second partial cable openings 574, 575 that cooperate to define cable openings 576 that align with the cable port 561 when the module 300a is assembled. The first and second wall portions 556, 560 include pre-defined fastener openings 579, 580 adjacent one of the cable openings 576 for receiving a fastener 581 (e.g., a screw) for securing the first and second wall portions 556, 560 of one of the walls 550 together.

The slots 312 for receiving the rails 310 of the pressurization frames 306, 308 are defined entirely by the first wall portions 556. The latches 314 are provided on the second wall portions 560. A head of the fastener 581 is accessible at the second wall portion 560 of one of the walls 550. The first and second wall portions 556, 560 meet at a mechanical interface that allows axial load to be transferred in both directions (axially inward and axially outward) between the first and second wall portions 556, 560. The interface can be provided by selected overlapping structures of the wall portions, mating structures of the wall portions, nested portions of the wall portions, and the like. In the depicted, an overlapped and nested configuration is used. For example, end legs 582 and pins 583 of the first wall portion 556 can be received in notches 584 and openings 585 define by the second wall portion 560.

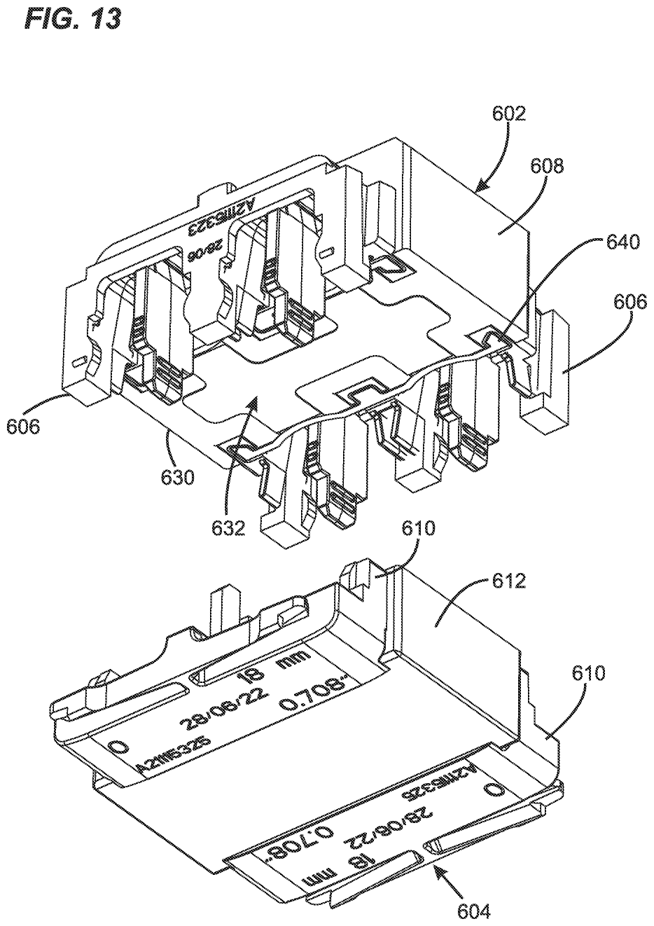

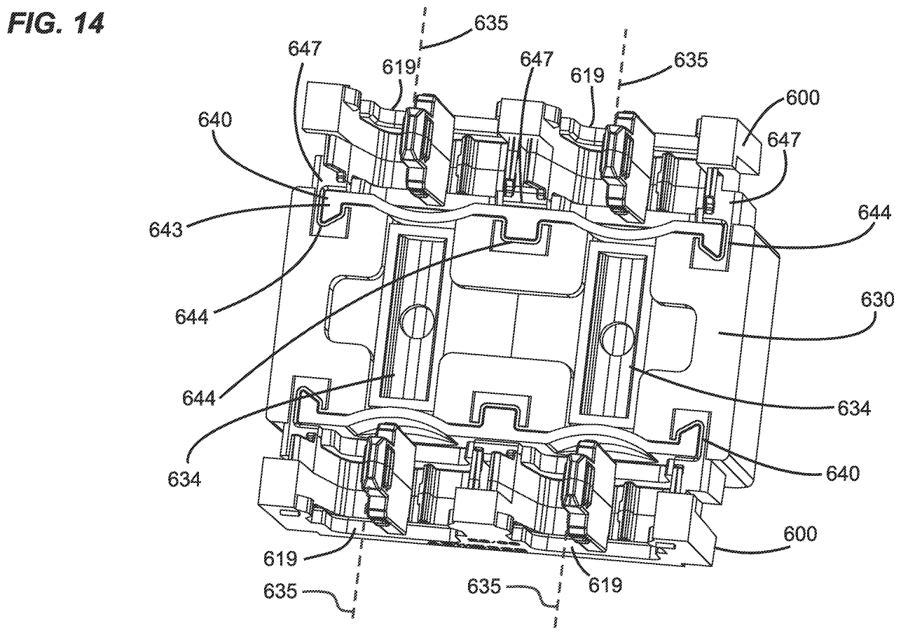

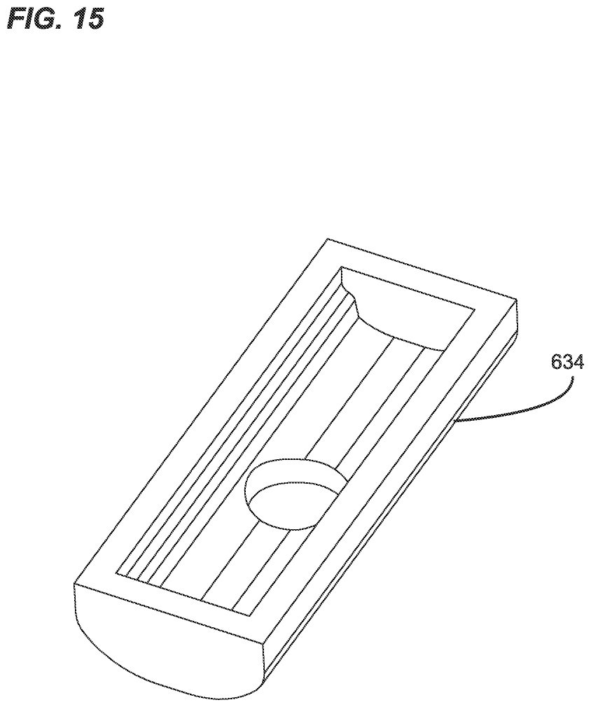

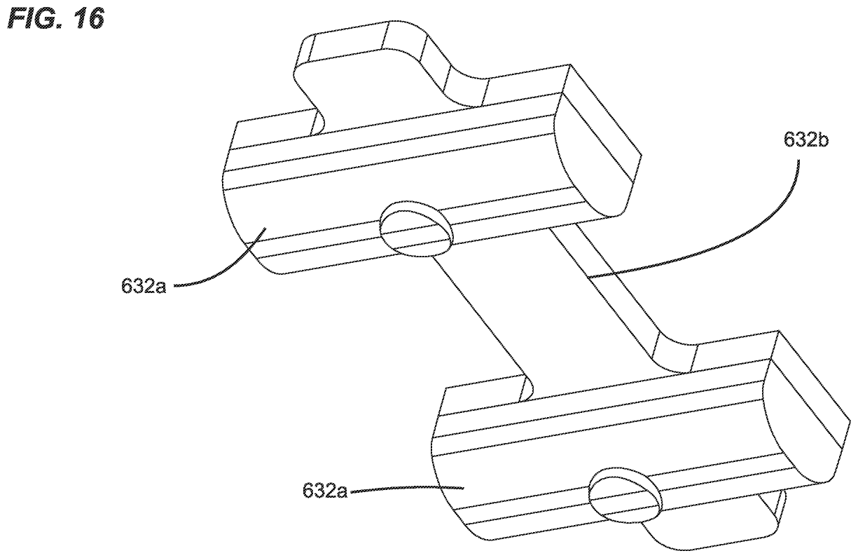

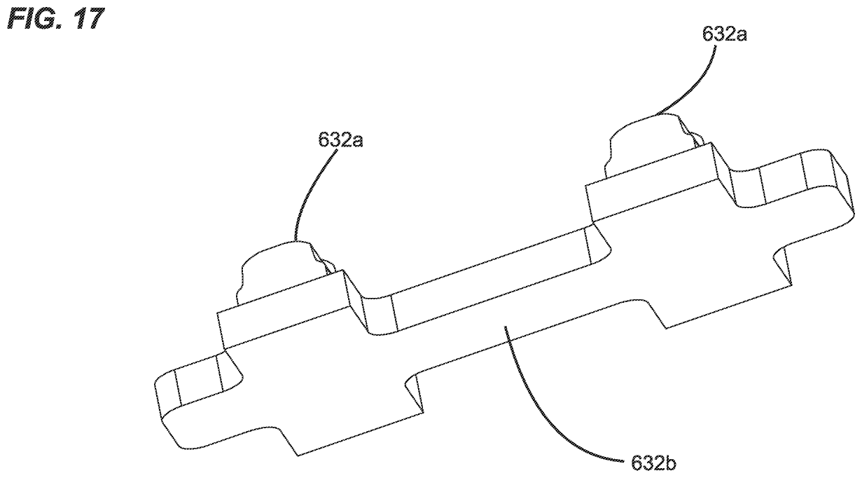

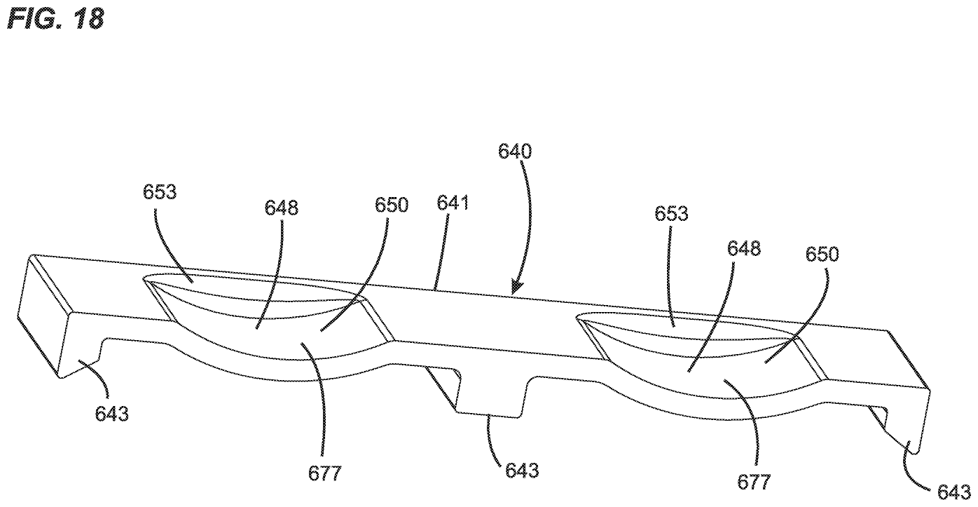

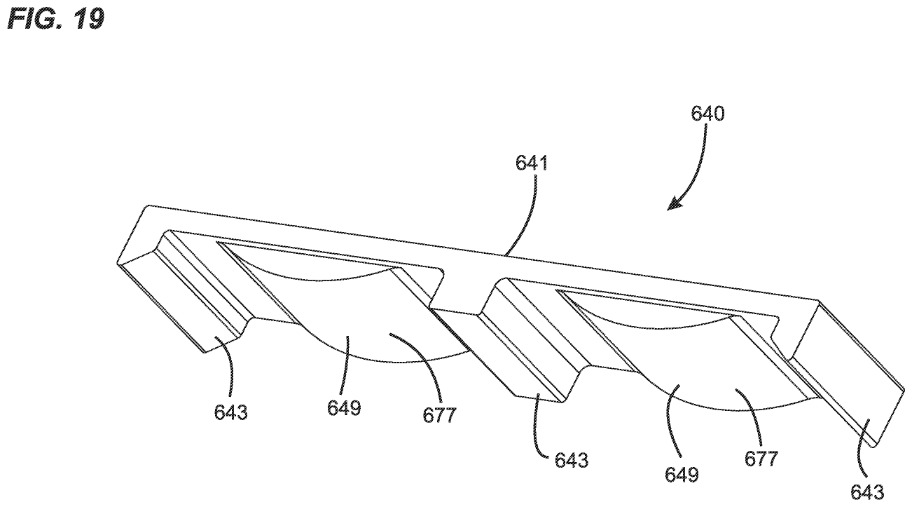

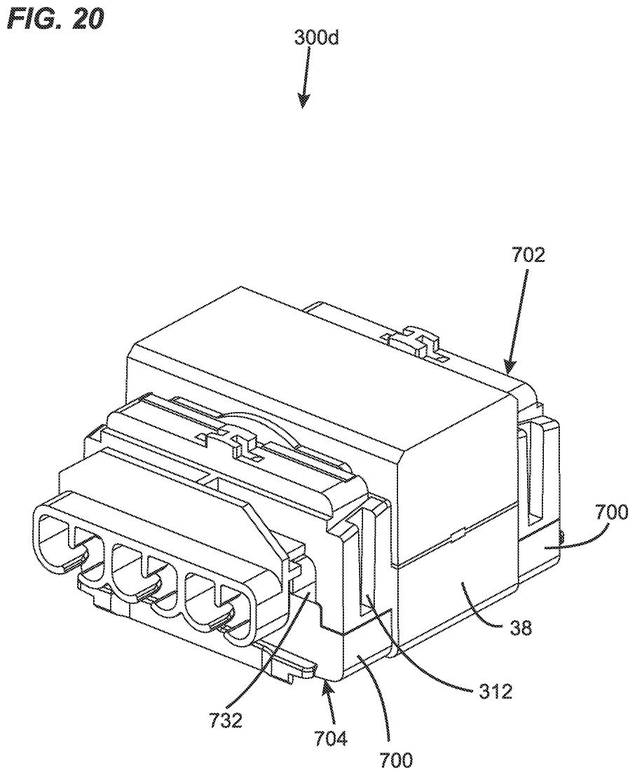

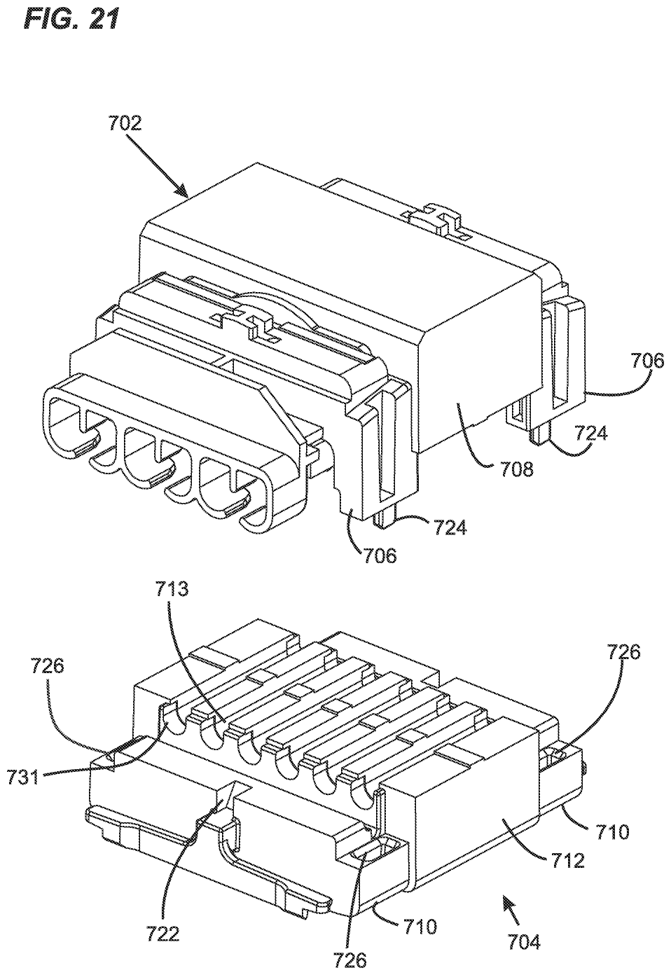

FIGS. 11-14 depict a third sealing module 300c adapted for use with the enclosure 20 and configured to be mounted between the inner and outer pressurization frames 306, 308 of the actuator arrangement. The sealing module 300c includes sealant 38 contained between sealant containment walls 600. The sealing module 300c includes a first body 602 and a second body 604 that mate together to form the sealing module 300c and that are separable to facilitate loading cables into the sealing module 300c. The sealing module 300c can be adapted for sealing a relatively wide range of cable sizes (e.g., diameters) and has features for reducing the volume of sealant between the containment walls 600 to accommodate larger cables.

The first body 602 includes first wall portions 606 of the sealant containment walls 600 and a first sealant portion 608 of the sealant 38. The first sealant portion 608 is secured (e.g., adhered) axially between the first wall portions 606. The second body 604 includes second wall portions 610 of the sealant containment walls 600 and a second sealant portion 612 of the sealant 38. The second sealant portion 612 is secured (e.g., adhered) axially between the second wall portions 610. The slots 312 for receiving the rails 310 of the pressurization frames 306, 308 are defined primarily by the first wall portions 606. The latches 314 are provided on the second wall portions 610. The first and second wall portions 606, 610 meet at a mechanical interface that allows axial load to be transferred in both directions (axially inward and axially outward) between the first and second wall portions 606, 610. The interface can be provided by selected overlapping structures of the wall portions, mating structures of the wall portions, nested portions of the wall portions, and the like. In the depicted example, an overlapped and nested configuration similar to the configuration of the first sealing module 300a in which overlapped regions at the center and the ends of the first and second wall portions 606, 610 provide three locations of support for transferring load between the first and second wall portions 606, 610 and preventing tilting between the first and second wall portions 606, 610.

The first and second wall portions 606, 610 cooperate to define cable openings 619 that define cable pass-through locations of the sealing module 300c. For smaller cables, dividers 621 can be mounted in the cable pass-through openings 619 to divide the cable pass-through openings 619 into smaller sections (e.g., half-sections) for receiving smaller cables in each of the sections. For larger cables, the dividers 621 can be removed to allow larger cables to be routed through the openings 619. To accommodate the larger cables, the first and second sealant portions 608, 612 each have a configuration which allows sealant (e.g., gel) to be removed from between the first and second wall portions 606, 610 to provide volume for accommodating the larger sized cables. As depicted at FIGS. 12-14, the configuration of each of the first and second sealant portions 608, 612 includes a main volume of sealant 630 and a removeable volume of sealant 632 molded within the main volume of sealant 630. To facilitate sealant removable, removeable containers 634 (e.g., elastomeric containers) are molded into the main volume of sealant 630. The containers 634 have an elongate configuration and extend lengthwise extend through the main volume of sealant 630 between the walls 600 in alignment with the openings 619. The containers 634 can be torn from the main volume of sealant 630 to provide volume reduction. First portions 632a of the removeable volume of sealant 630 fill the containers 634 or overfill the containers 634 but coincide with the boundary defined by the containers 634. The first portions 632a are elongate and extend between the cable pass-through openings 619 along cable pass-through axes 635. A second portion 632b of the removeable volume of adhesive extends transversely relative to the first portions 632a and the axes 635 at a central region between the walls 600. The second portion extends outside the boundaries defined by the containers 634 and forms a central removeable core of the first and second sealant portions 608, 612.

The sealing module 300c also includes an axial sealant containment barrier formed by the cooperation of sealant barriers 640 mounted to each of the first and second wall portions 606, 610. In certain examples, the sealant barriers 640 can be elastomeric and can have a continuous construction. In certain examples, the sealant barriers 640 can be elastomeric sheets. In certain examples, the elastomeric sheets can be molded sheets shaped to include integrated features such as enlargements (e.g., projections, rails, ribs, flanges, etc.). In the depicted example, the sealant barriers 640 are molded elastomeric (e.g., rubber or rubber-like) sheets 641 including attachment rails 643 that fit within slots 644 defined by the wall portions 606, 610. The slots 644 can be defined within projections 645 of the wall portions 606, 610 that project into the main volume of sealant 630. Open sides of the slots 644 can be opposed by retaining portions 647 of the wall portions 606, 610 to prevent the attachment rails 643 from disengaging from the slots 644. The sheets 641 can include curved sections 677 that oppose the cable openings 619. The curved sections 677 can have concave sides 648 that face toward the cable openings 619 and convex sides 649 that face toward the sealant portions 608, 612. In one example, the concave sides 648 can form pockets 650 with the concave sides 638 being recessed with respect to a primary surface 651. The pockets 650 can have closed ends 653 and open ends 654. The open ends 654 of the pockets 650 of the sheets 641 corresponding to the first and second wall portions 606, 610 are adjacent to each other (e.g., oppose each other) when the sealing module 300c is assembled. The curved sections 647 can deform to allow cables routed through the openings 619 to pass between the opposing sheets 641 located at each of the sealant containment walls 600.

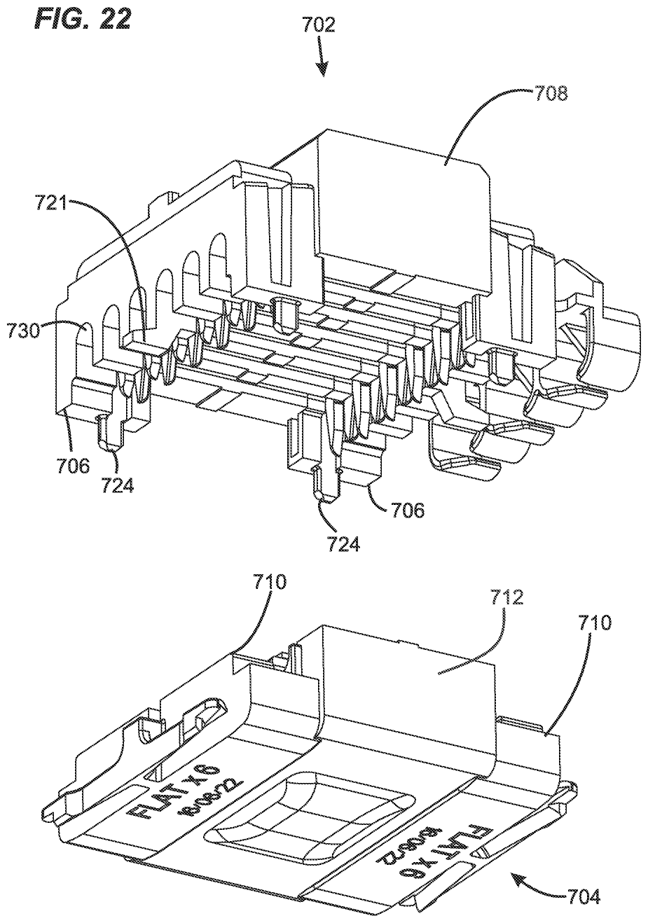

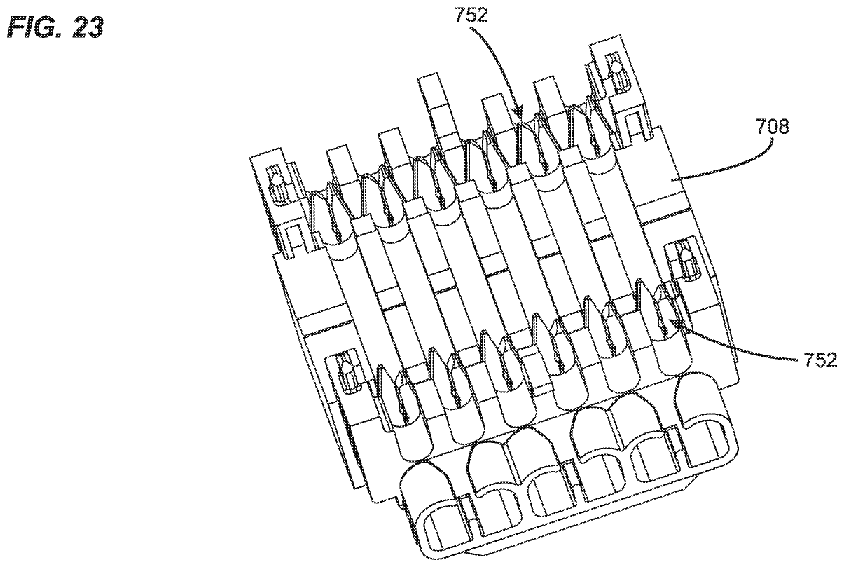

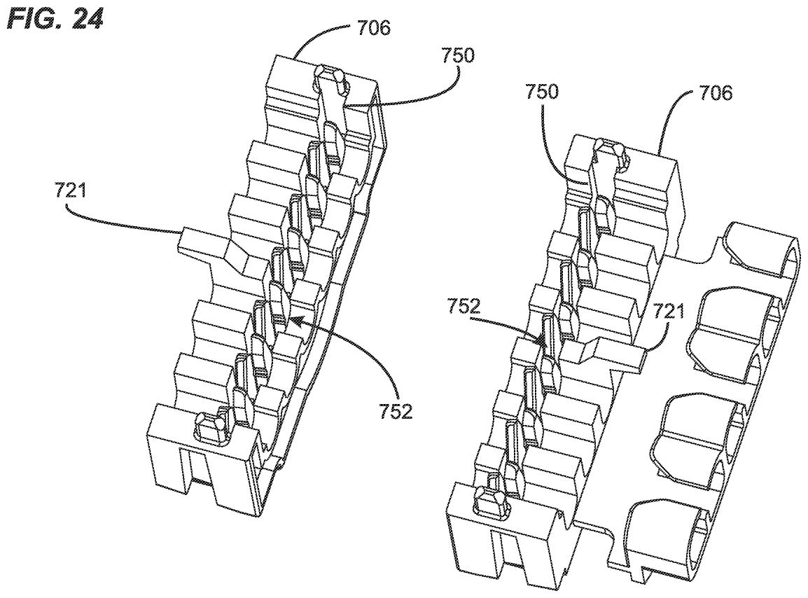

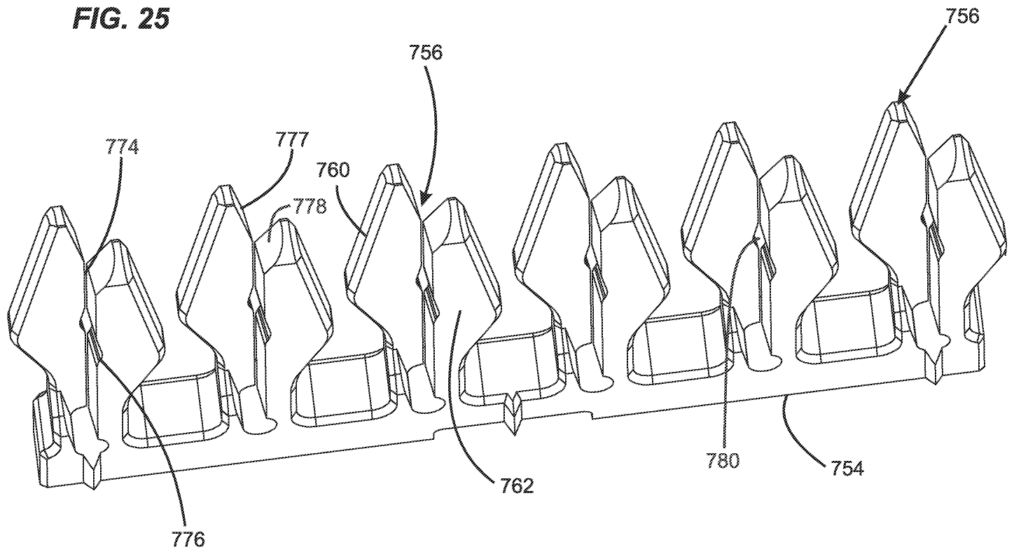

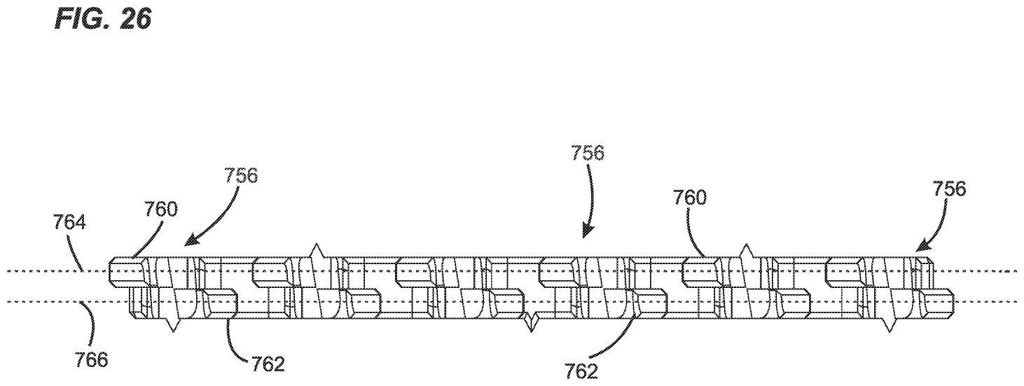

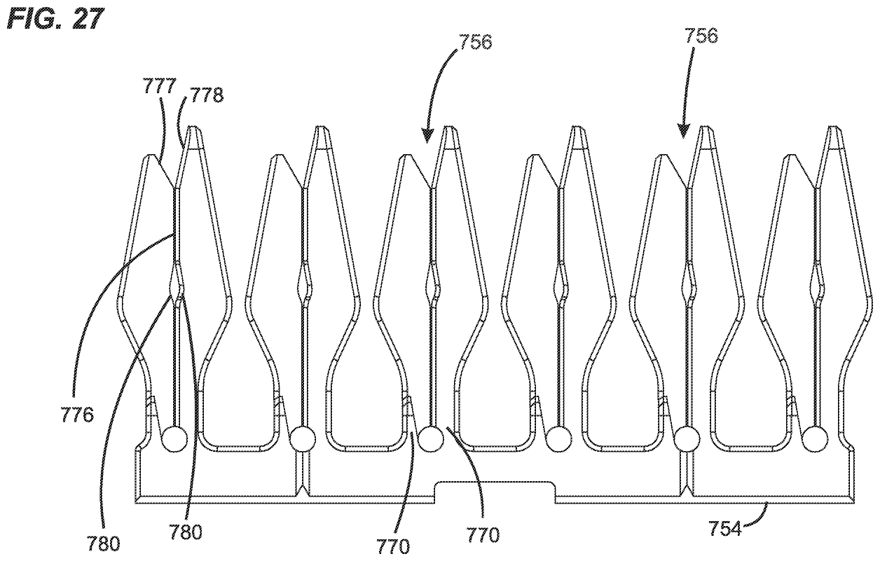

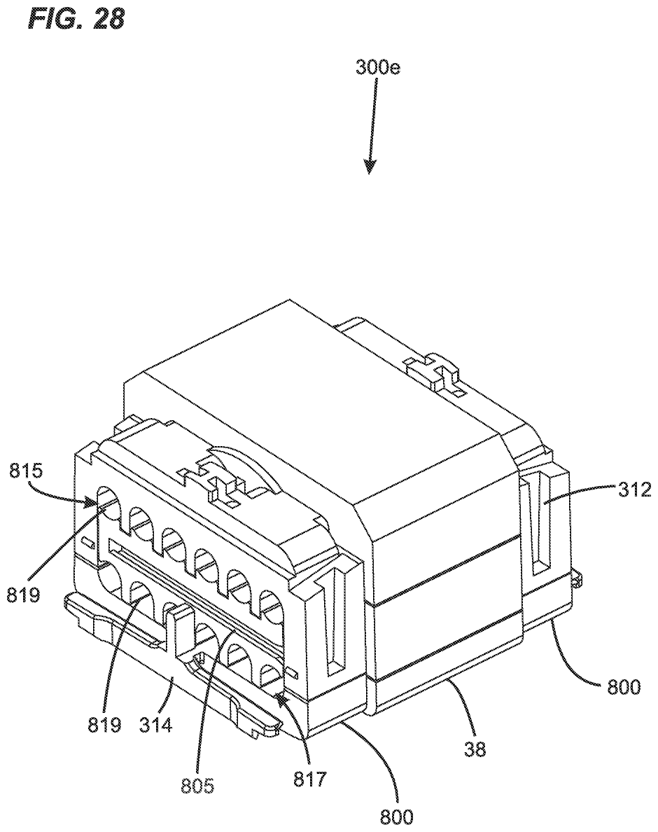

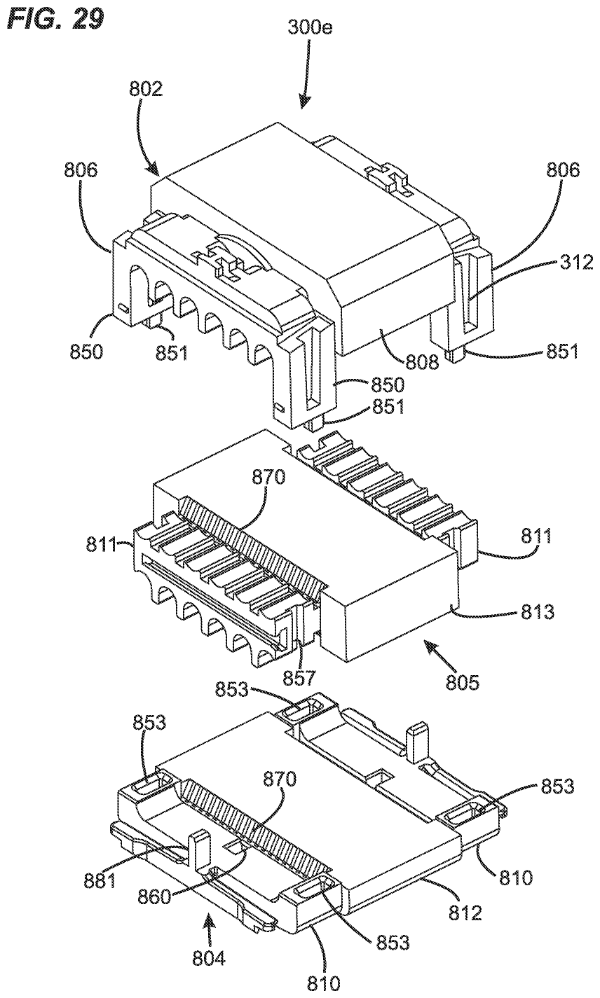

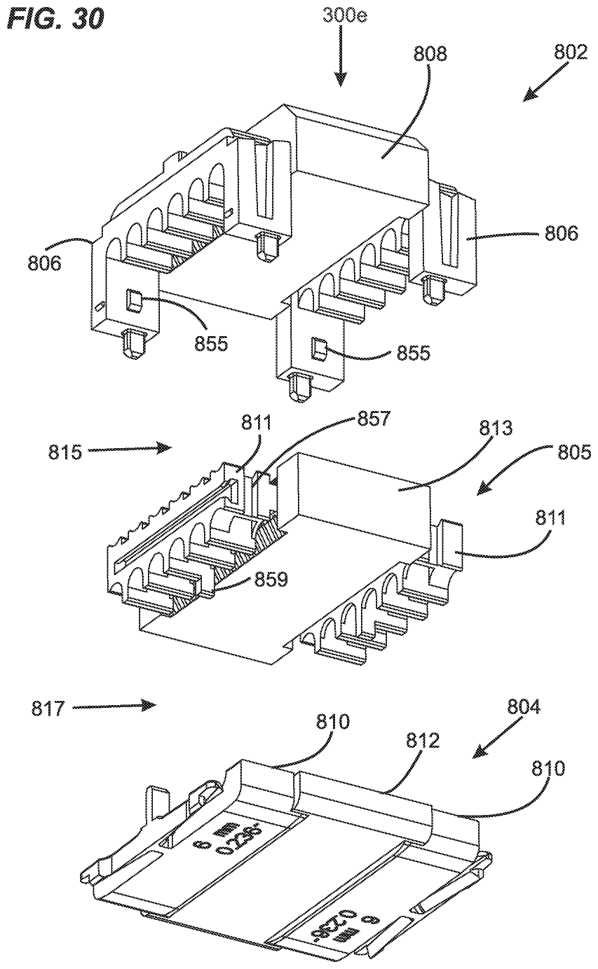

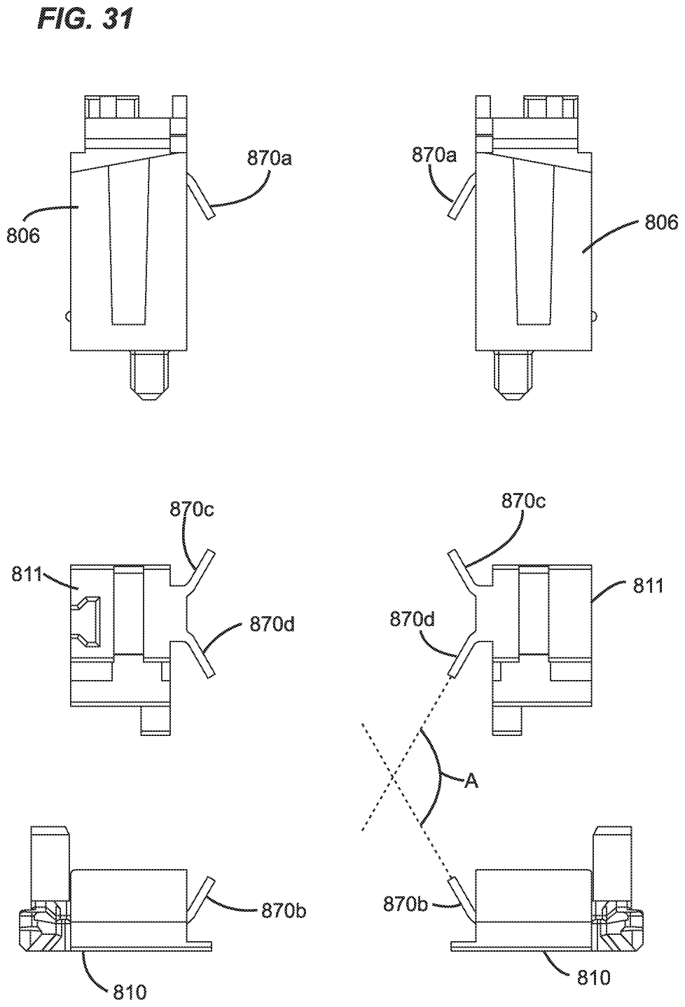

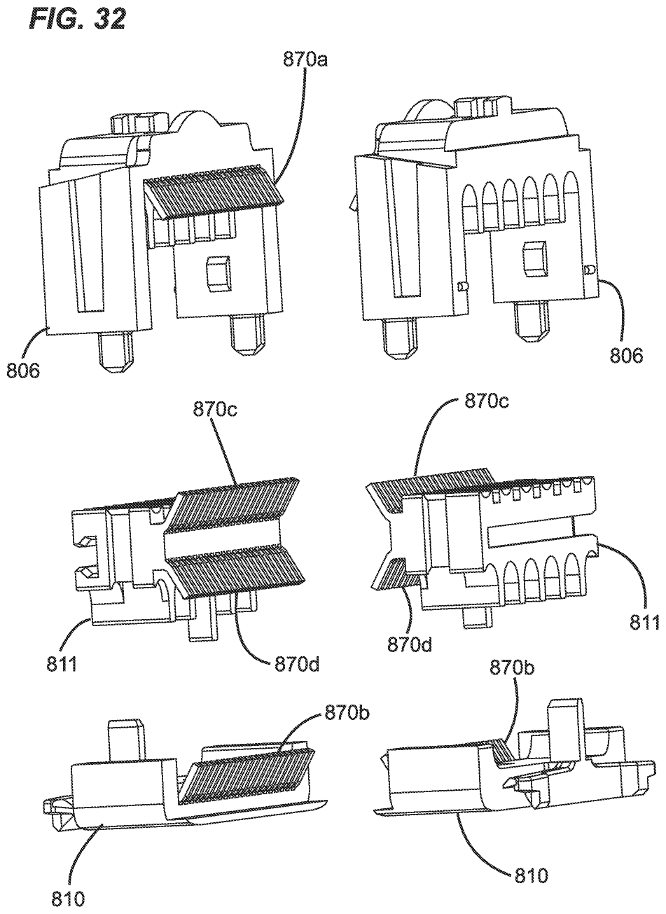

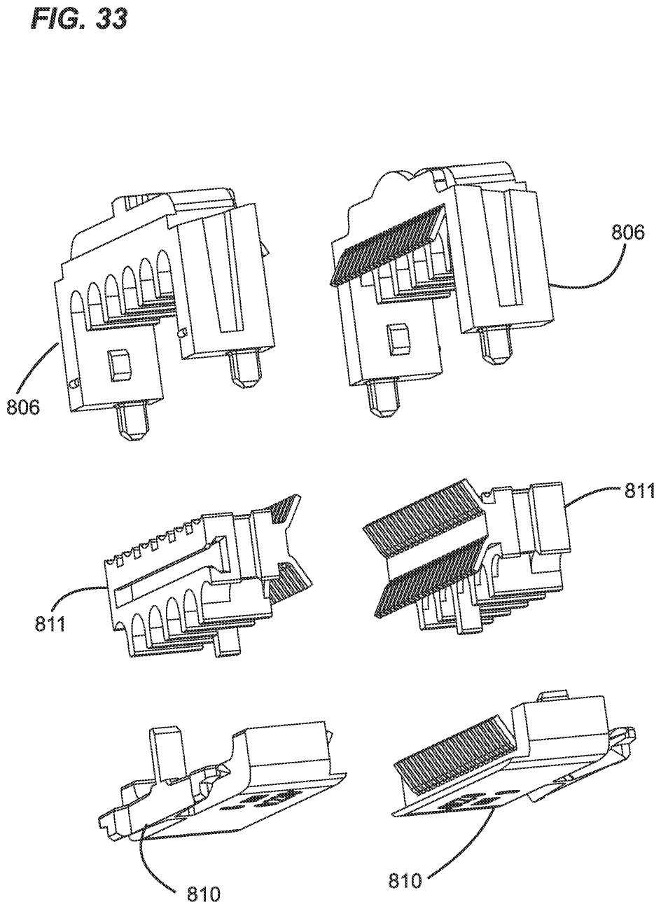

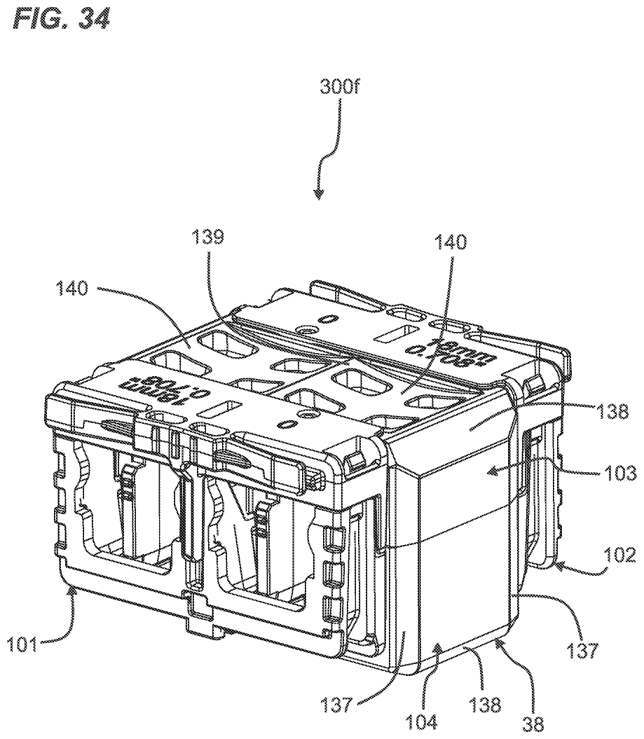

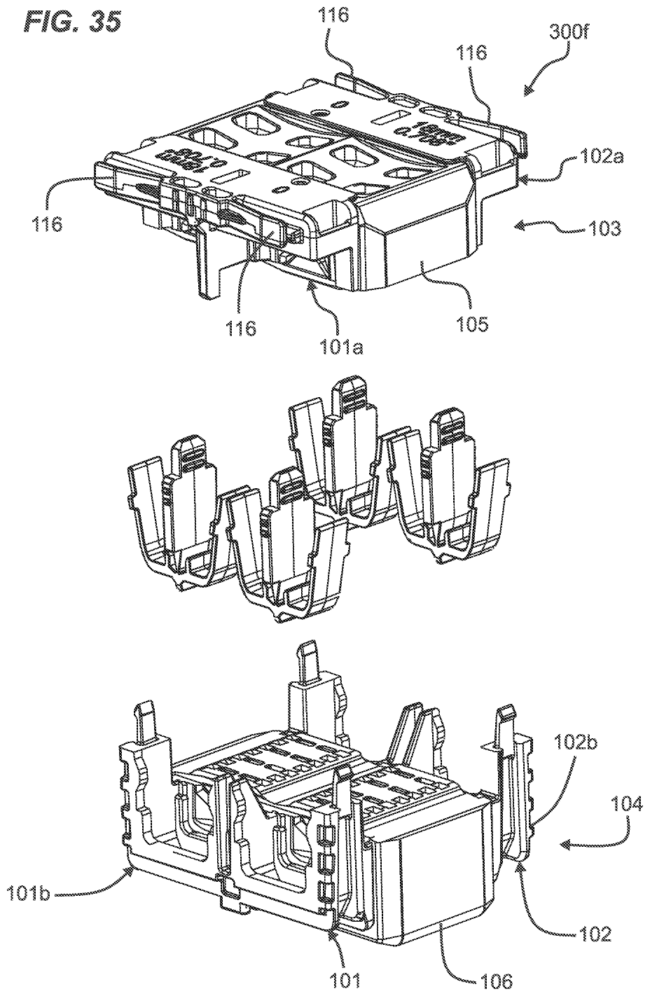

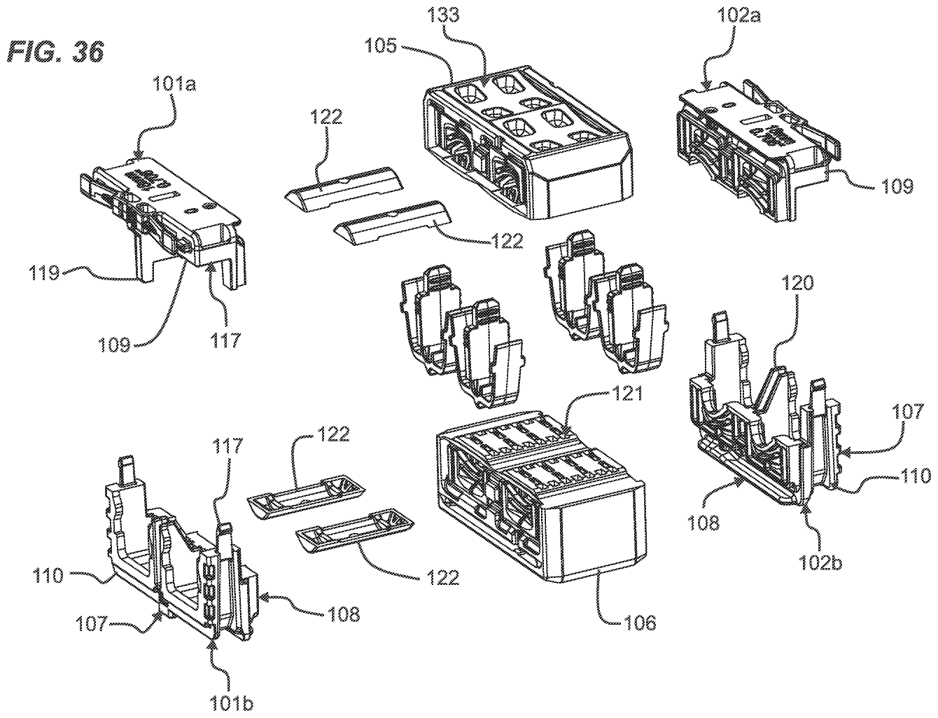

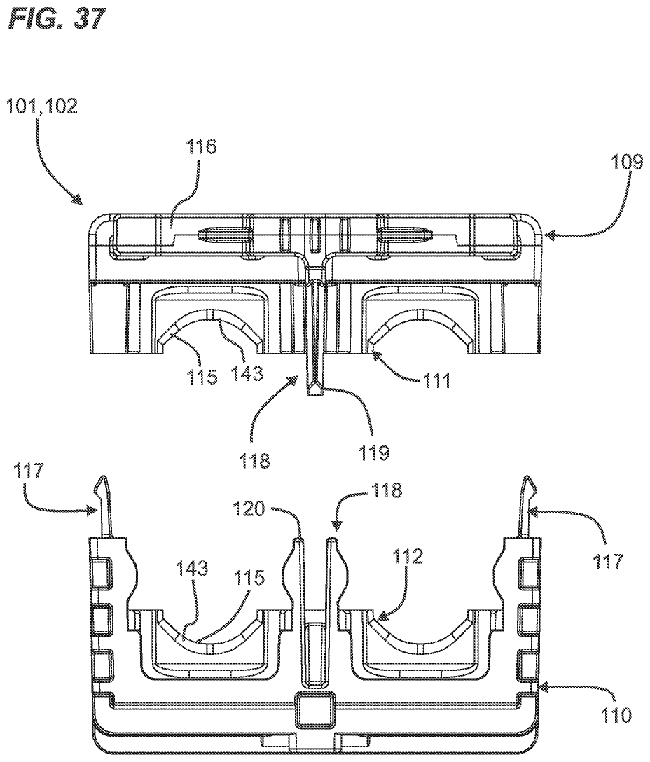

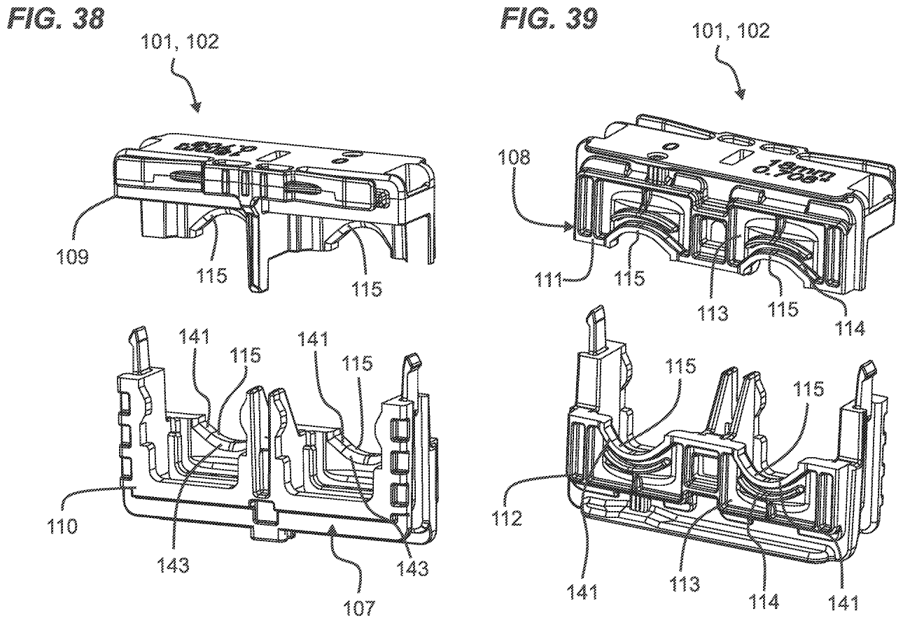

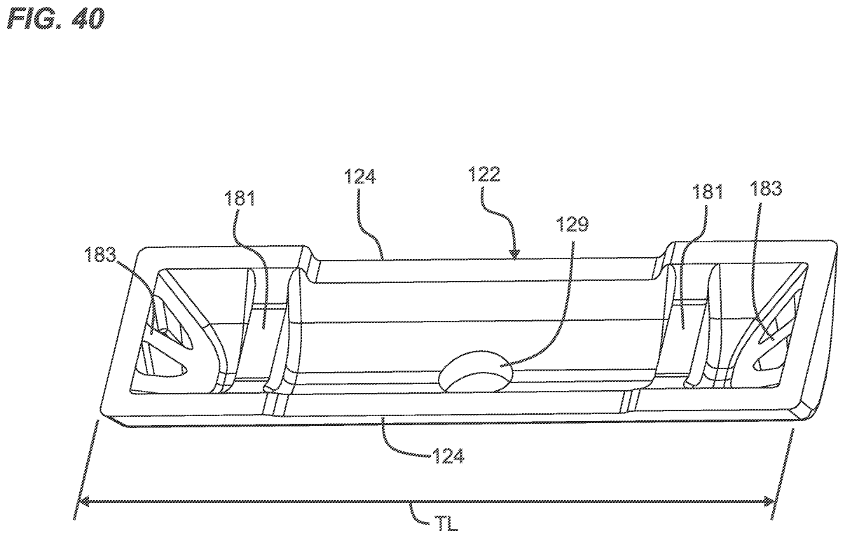

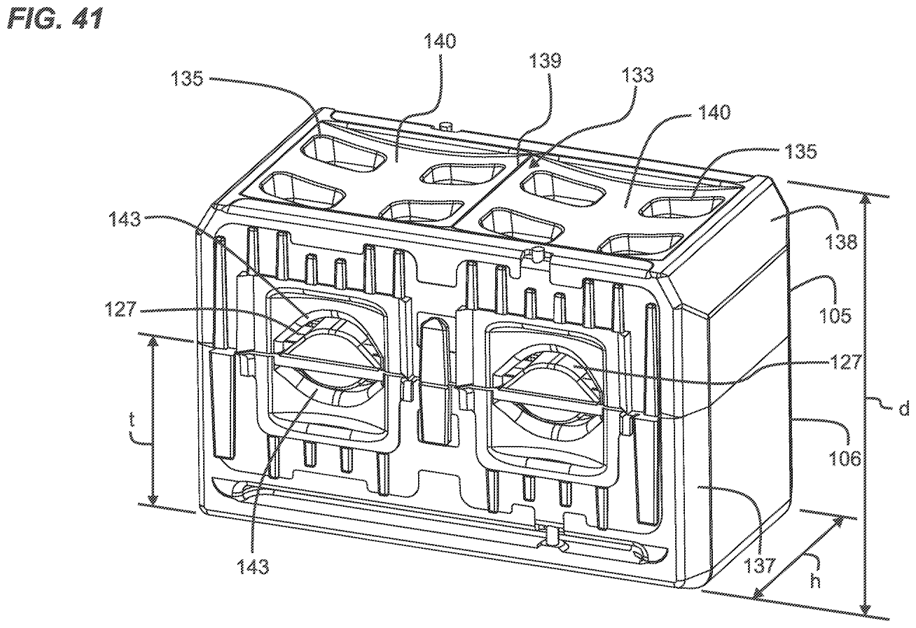

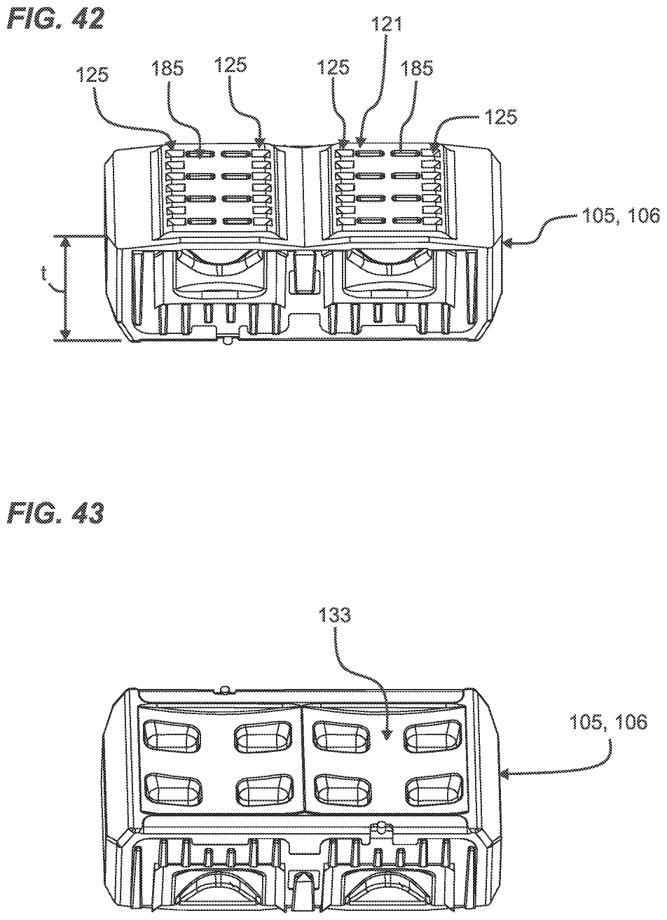

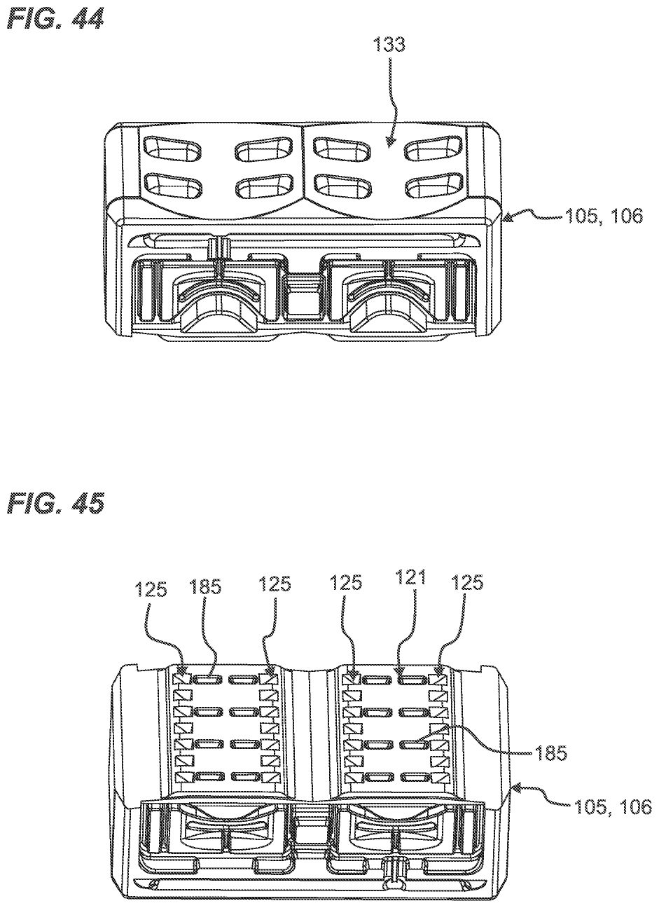

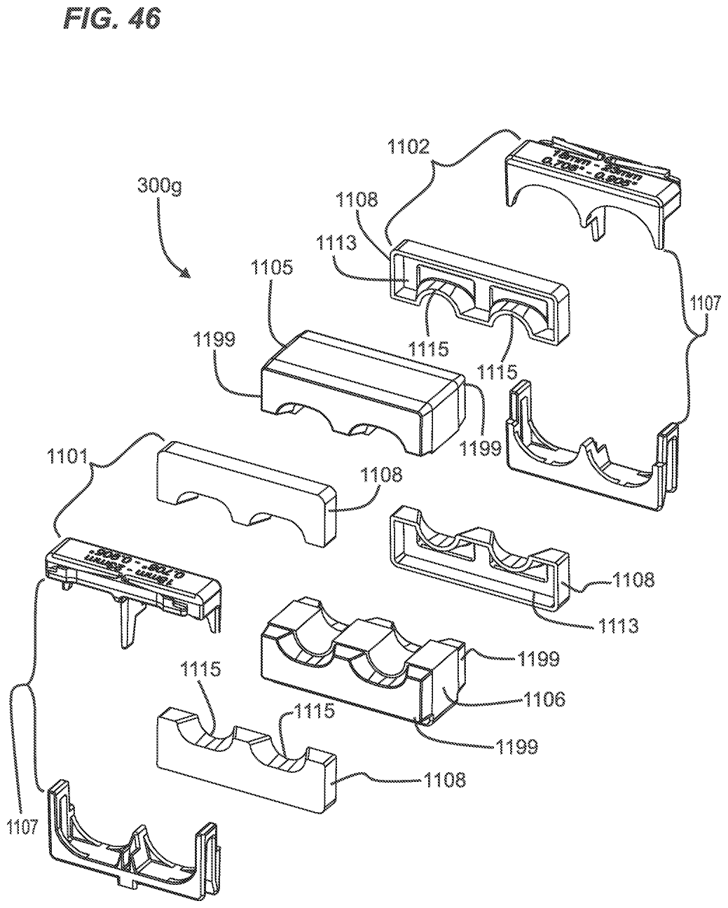

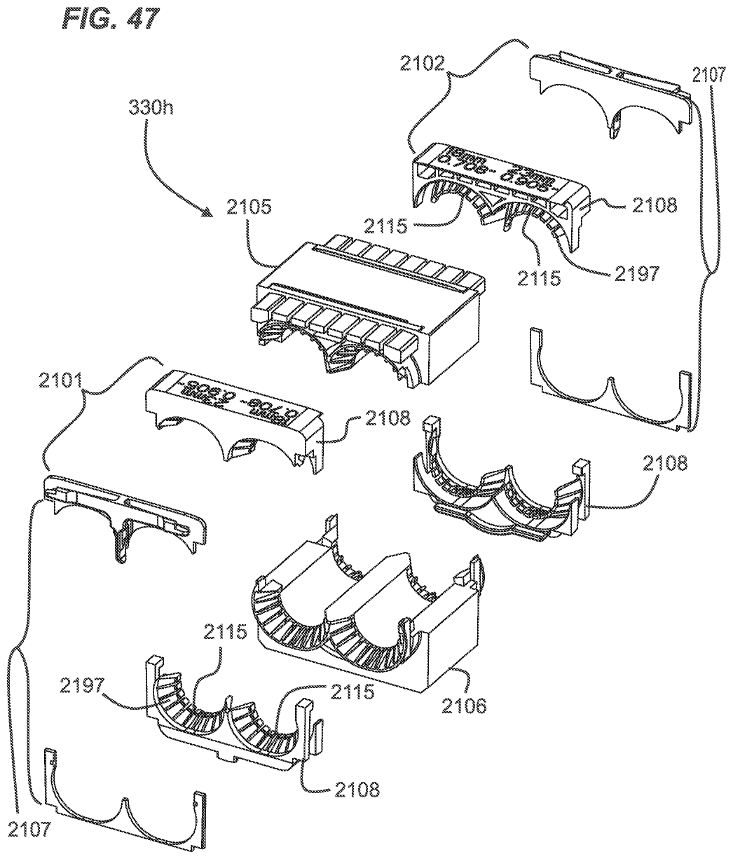

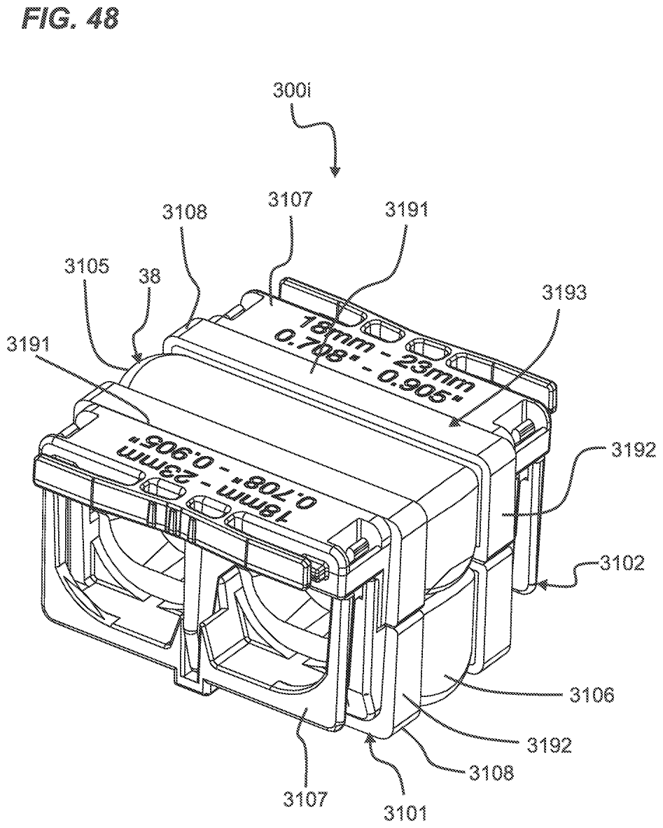

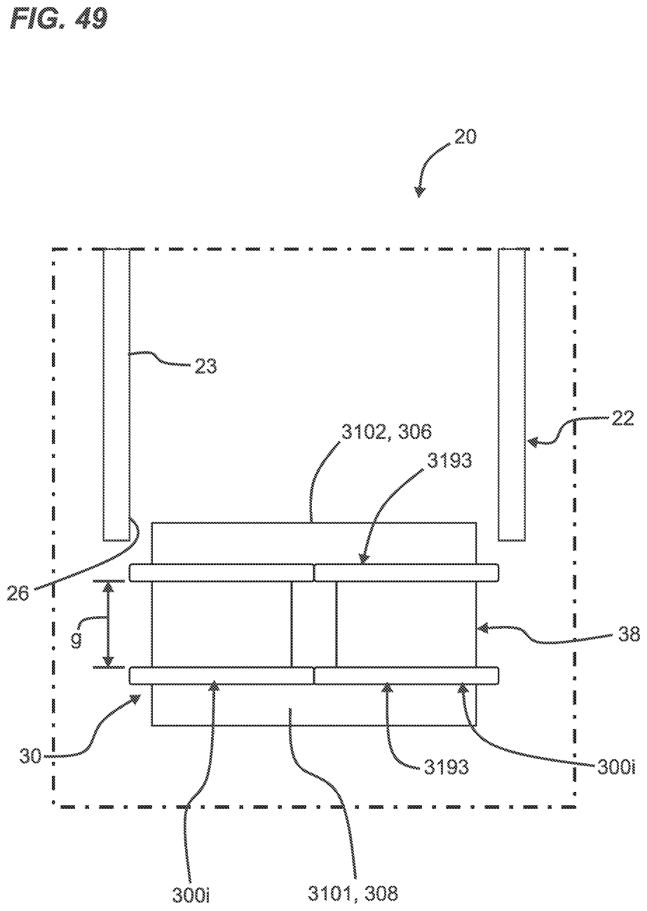

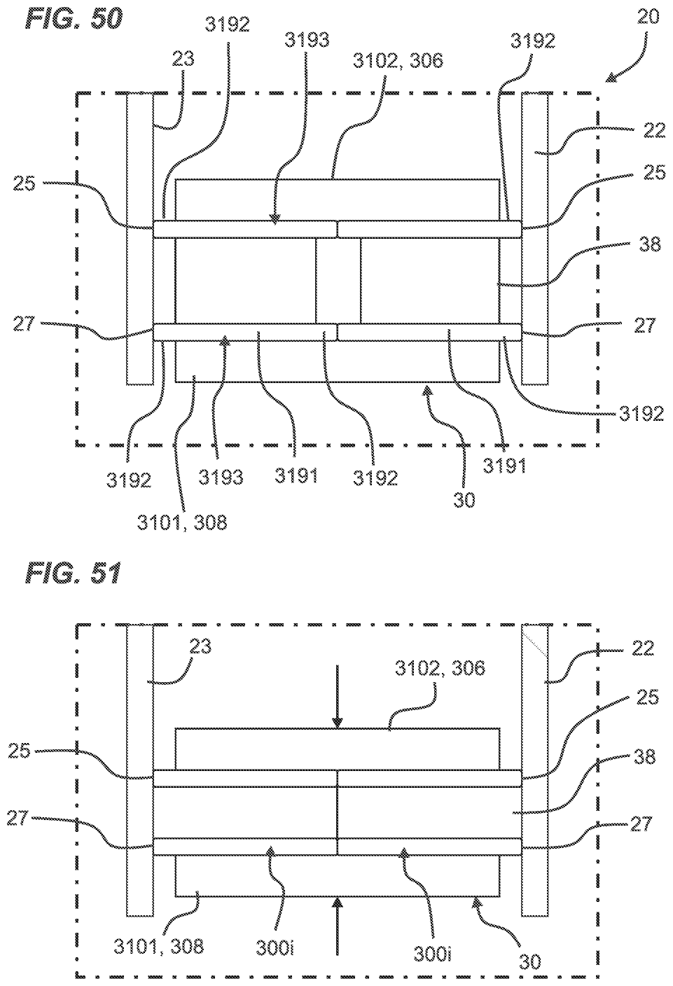

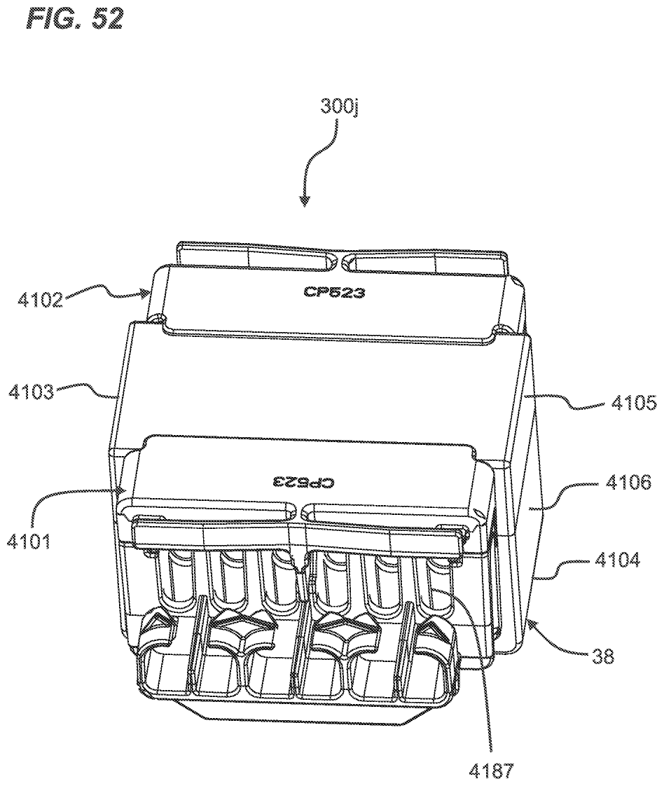

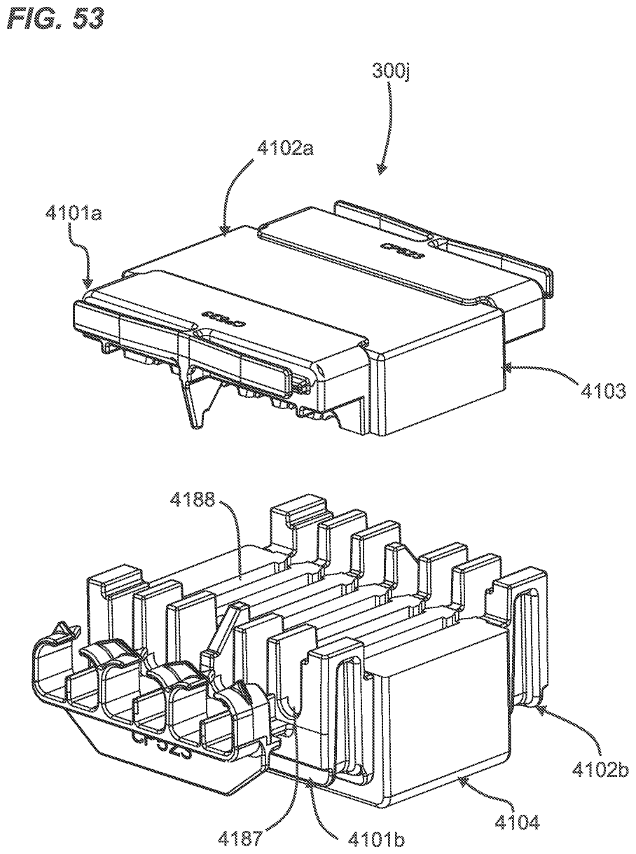

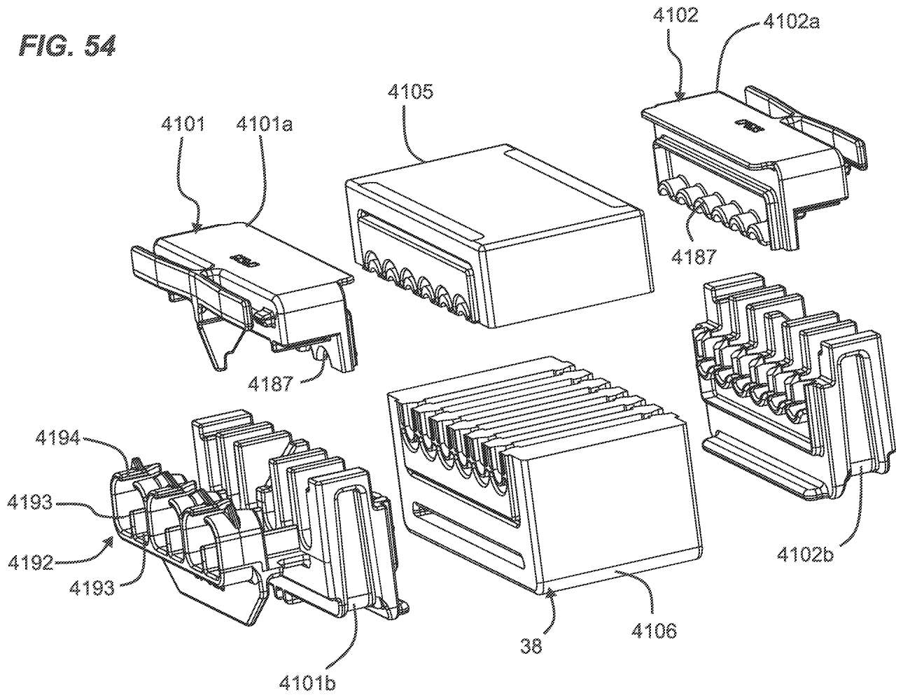

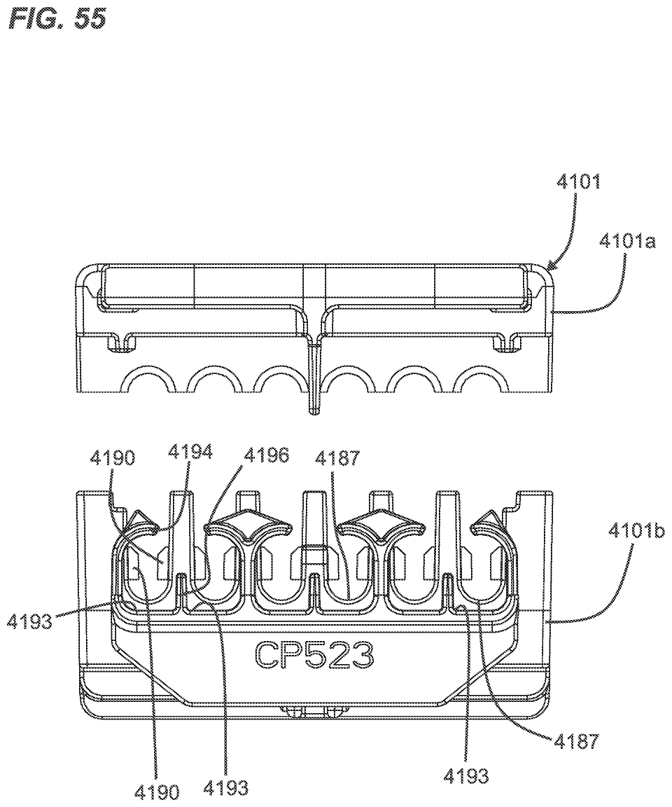

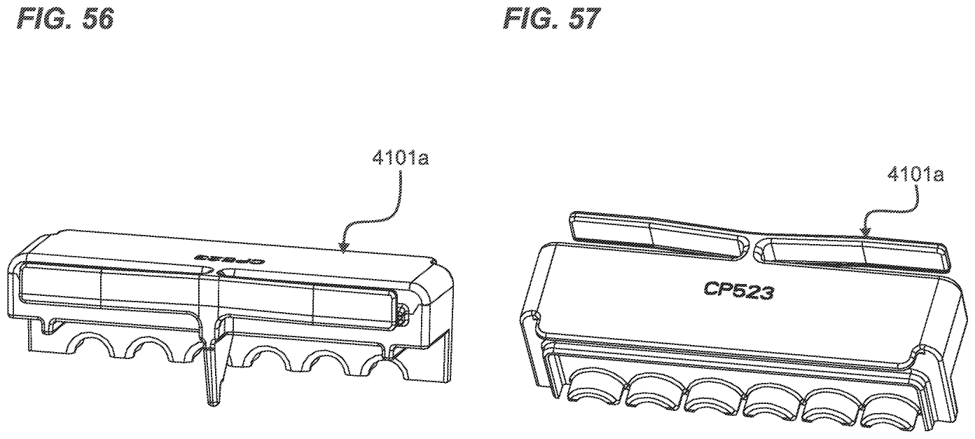

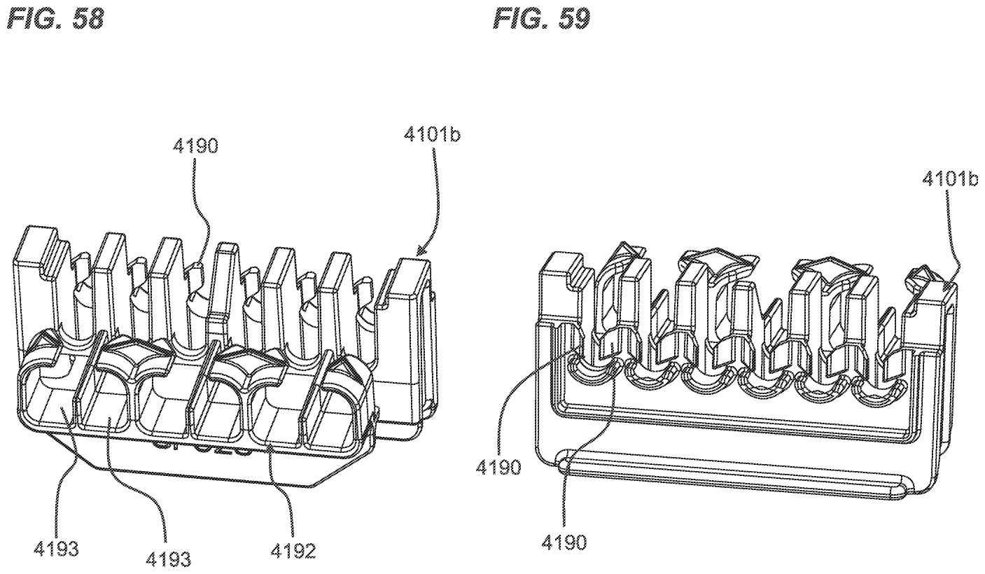

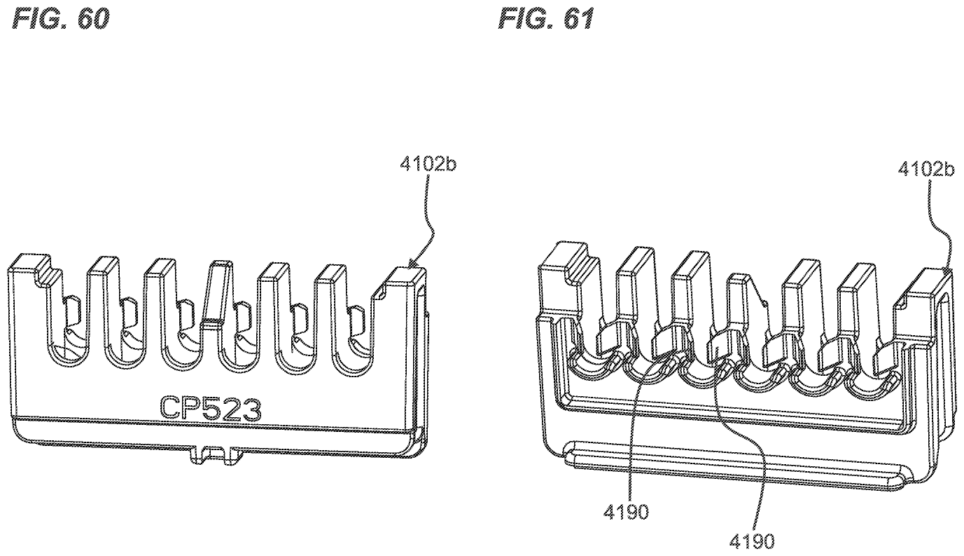

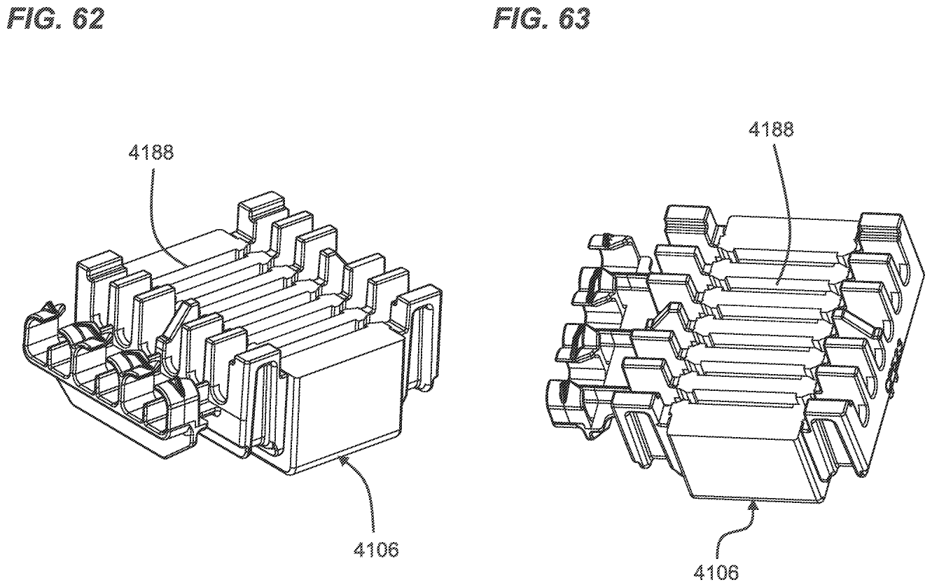

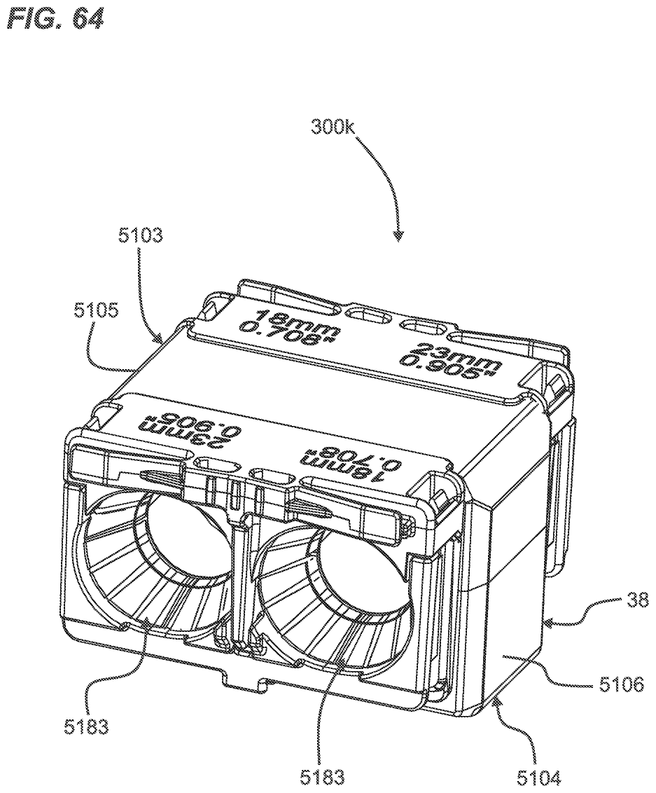

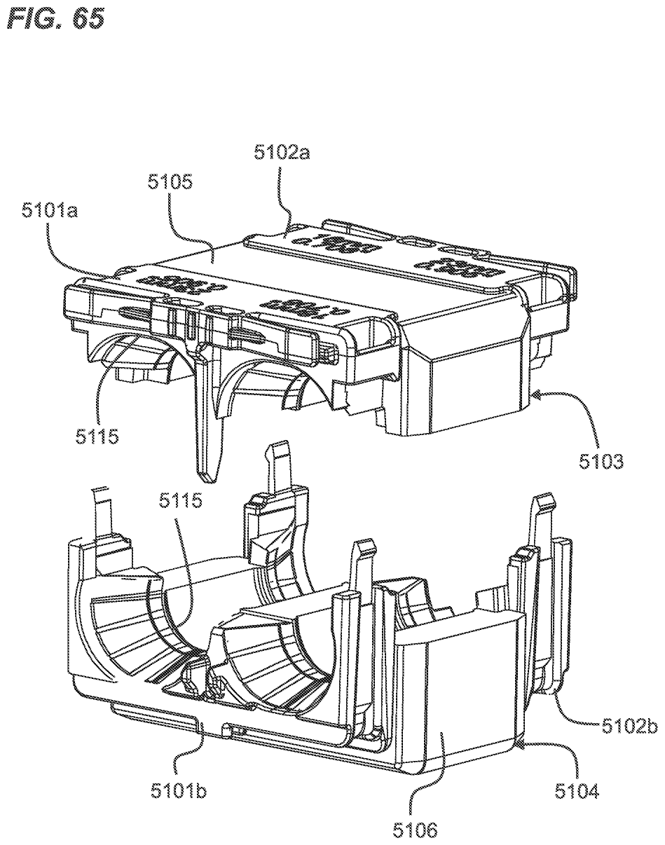

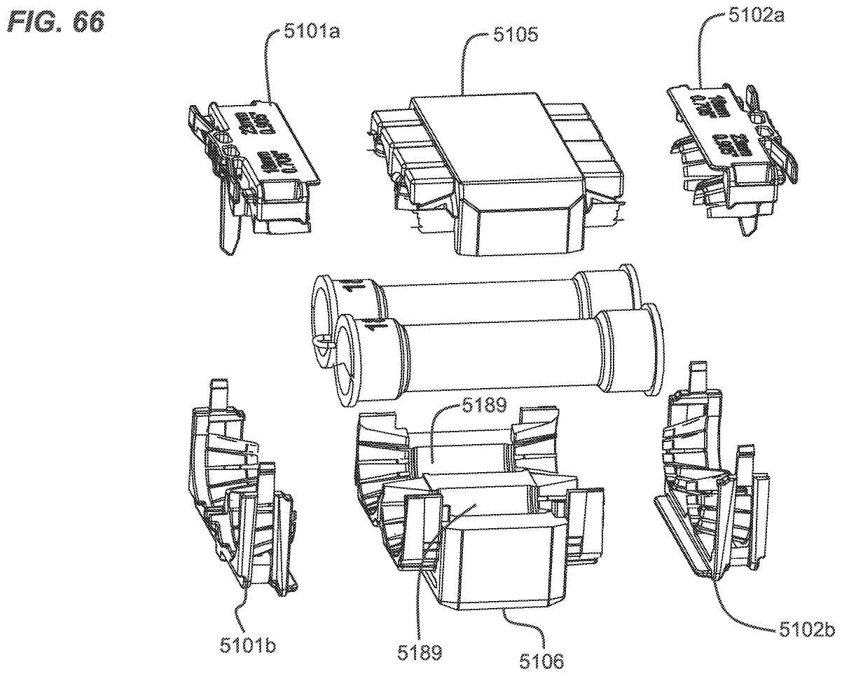

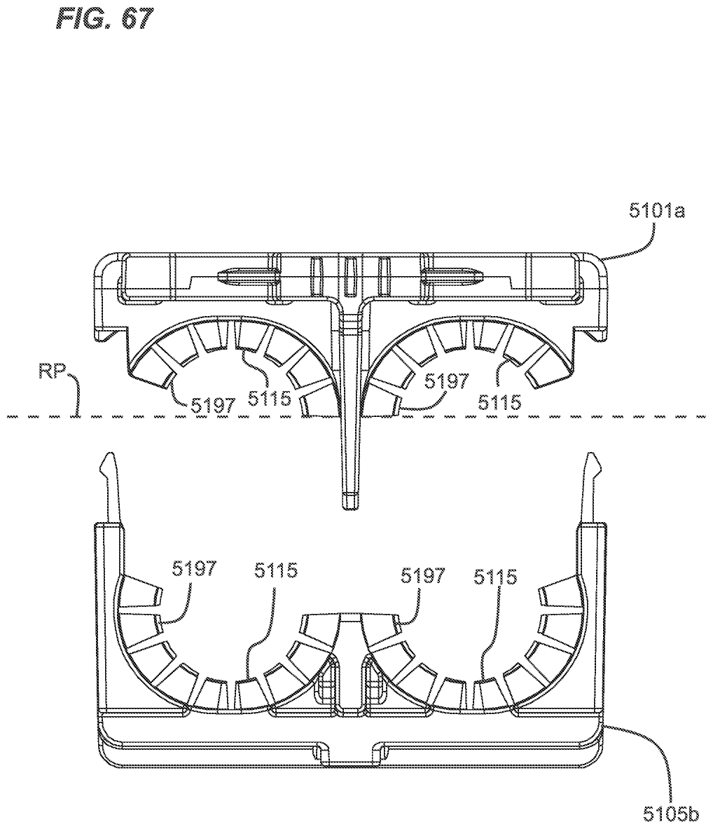

FIGS. 20-27 depict a fourth sealing module 300d adapted for use with the enclosure 20 and configured to be mounted between the inner and outer pressurization frames 306, 308 of the actuator arrangement. The sealing module 300d includes sealant 38 contained between sealant containment walls 700. The sealing module 300d includes a first body 702 and a second body 704 that mate together to form the sealing module 300d and that are separable to facilitate loading cables into the sealing module 300d. The first body 702 includes first wall portions 706 of the sealant containment walls 700 and a first sealant portion 708 of the sealant 38. The first sealant portion 708 is secured (e.g., adhered) axially between the first wall portions 706. The second body 704 includes second wall portions 710 of the sealant containment walls 700 and a second sealant portion 712 of the sealant 38. The second sealant portion 712 is secured (e.g., adhered) axially between the second wall portions 710. The first and second sealant portions 708, 712 cooperate to define a plurality of cable ports 713 that extend axially between the containment walls 700.

The first and second wall portions 706, 710 also respectively include partial cable openings 730, 731 that cooperate to define cable openings 732 that align with the cable ports 713 when the module 300d is assembled. The cable ports 713 can be filled with plugs when not occupied by cables.

The slots 312 for receiving the rails 310 of the pressurization frames 306, 308 are defined primarily by the first wall portions 706. The latches 314 are provided on the second wall portions 710. The first and second wall portions 506, 510 meet at a mechanical interface that allows axial load to be transferred in both directions (axially inward and axially outward) between the first and second wall portions 706, 710. The interface can be provided by selected overlapping structures of the wall portions, mating structures of the wall portions, nested portions of the wall portions, and the like. In the depicted example, a central post 721 of the first wall portion 706 fits within a central notch 722 of the second wall portion 710, and end posts 724 of the first wall portion 706 fit within end openings 726 of the second wall portion 710 to provide 3-location reinforcement between the opposing first and second wall portions 706, 710.

The first wall portions 706 define slots 750 transversely oriented relative a cable pass-through orientation of the sealing module 300d. Sealant containment devices 752 are secured in the slots 750. The sealant containment devices 752 include base strips 754 that can be secured (e.g., press-fit) within the slots 750. The containment devices 752 include a plurality of clips 756 attached to the base strips 754 (e.g., unitarily formed with the base strips 754). In one example, the base strips 754 and the clips 756 are formed as a unitary molded plastic part. The clips 756 are located in alignment with the ends of the cable ports 713 and are positioned between the first and second sealant portions 708, 712 and the cable openings 732 of the containment walls 700. Each clip is formed by first and second resilient clip arms 760, 762 having base ends connected to the base strip 754. The clip arms 760, 762 can resiliently flex relative to the base strip 754 between closed positions and open positions. A cable can be pressed between the clip arms 760, 762 of a given clip 756 to move the clip arms 760, 762 from the closed position to the open position. The clip arms 760, 762 are resiliently biased toward the closed positions and can be configured to grip on a cable routed between the clip arms 760, 762. The first and second clip arms 760, 762 are axially offset from one another. For example, the first clip arms 760 of one of the containment devices 752 can be aligned along a first reference plane 764 and the second clip arms 762 of the containment device 752 can be aligned along a second reference plane 766 offset from and parallel to the first reference plane 764. The reference planes 764, 766 can be transversely oriented relative to a cable pass-through orientation of the sealing module 300d. The clip arms 760, 762 can have pre-determined flex locations 770 (e.g., discrete areas of reduced cross-section) adjacent the base ends of the clip arms 760, 762. The first and second clip arms 760, 762 can include cable engagement surfaces 774, 776 that face in opposite directions and can include ramped surfaces 777, 778 adjacent free ends of the clip arms 760, 762 for facilitating spreading the flip arms 760, 762 apart by forcing a cable between the clip arms 760, 762. Notches 780 can be provided for holding a cable centered between the clip arms. In one example, one of the first and second clip arms 760, 762 is longer than the other of the first and second clip arms 760, 762.

FIGS. 28-33 depict a fifth sealing module 300e adapted for use with the enclosure 20 and configured to be mounted between the inner and outer pressurization frames 306, 308 of the actuator arrangement. The sealing module 300e includes sealant 38 contained between sealant containment walls 800. The sealing module 300e includes a first body 802, a second body 804 and an intermediate third body 805 that mate together to form the sealing module 300e and that are separable to facilitate loading cables into the sealing module 300e. The first body 802 includes first wall portions 806 of the sealant containment walls 800 and a first sealant portion 808 of the sealant 38. The first sealant portion 808 is secured (e.g., adhered) axially between the first wall portions 806. The second body 804 includes second wall portions 810 of the sealant containment walls 800 and a second sealant portion 812 of the sealant 38. The second sealant portion 812 is secured (e.g., adhered) axially between the second wall portions 810. The third body 805 mounts between the first and second bodies 802, 804 and includes third wall portions 811 of the sealant containment walls 800 and a third portion 813 of the sealant 38. The third sealant portion 813 is secured (e.g., adhered) axially between the third wall portions 811. First cable pass-through locations 815 are defined between the first and third sealant portions 808, 813 and second cable pass-through locations 817 are defined between the third and second sealing portions 813, 812. The first and second cable pass-through locations 815, 817 do not define discrete cable ports, instead the locations are defined by opposing flat surfaces between which cables can be routed that deform to accommodate the cables routed therethrough. Cable openings 819 defining specific cable pass-through points at the cable pass-through locations 815, 817 are defined by the containment walls 800 via the cooperation of the first, second and third wall portions 806, 810 and 811.

The slots 312 for receiving the rails 310 of the pressurization frames 306, 308 are defined primarily by the first wall portions 806. The latches 314 are provided on the second wall portions 810. The first and second wall portions 806, 810 meet at a mechanical interface that allows axial load to be transferred in both directions (axially inward and axially outward) between the first and second wall portions 806, 810. The interface can be provided by selected overlapping structures of the wall portions, mating structures of the wall portions, nested portions of the wall portions, and the like. In the depicted example, end arms 850 of the first wall portions 806 include posts 851 that fit within receptacles 853 of the second wall portions 810. The third wall portions 811 mount between the first and second wall portions 806, 810 and are straddled by the end arms 850. Tabs 855 on the end arms fit within slots 857 at ends of the third wall portions 811. The third wall portions 811 include central projections 859 that fit within central openings 860 defined by the second wall portions 810 adjacent the second sealant portion 812. The second wall portions 810 include central projections 881 that capture the third wall portion 811 within the first wall portion 806.

Comb structures 870 are used to provide sealant containment at the first and second cable pass-through locations 815, 817. Each of the comb structures 870 includes a linear row of comb fingers which extends across the length of the module 300e. A pair of the comb structures 870 is provided at each end of each of the cable pass-through locations 815, 187. Each pair of comb structures 870 is oriented such that free ends of the comb fingers are adjacent each other with the comb fingers defining an included angle A in the range of 80-160 degrees or in the range of 90-150 degrees. As depicted, the comb structures include first comb structures 870a formed with the first wall portions 806, second comb structures 870b formed with the second wall portions 810, third comb structures 870c formed with the third wall portions 811 adjacent the first comb structures 870a, and fourth comb structures 870d formed with the third wall portions 811 adjacent the second comb structures 870b. The comb fingers of each comb par have a resilient construction and are configured to flex apart to accommodate cables passed through the cable pass-through locations 815, 817.

FIGS. 34-45 depict a cable sealing device including a sixth sealing module 300f adapted for use with the enclosure 20 and configured to be mounted between the inner and outer pressurization frames 306, 308 of the actuator arrangement. The sealing module includes sealant 38 contained axially between first and second sealant containment walls 101, 102. The sealing module 300f includes first and second bodies 103, 104 that join together to form the cable sealing module 300f and that are separable to facilitate routing a cable between the first and second bodies 103, 104. The first body 103 includes first wall portions 101a, 102a of the sealant containment walls 101, 102 and a first sealant portion 105 of the sealant 38. The first sealant portion 105 is secured axially between the first wall portions 101a, 102a. The second body 104 includes second wall portions 101b, 102b of the sealant containment walls 101, 102 and a second sealant portion 106 of the sealant 38. The second sealant portion 106 is secured axially between the second wall portions 101b, 102b. It will be appreciated that the first and second sealant containment walls 101, 102 can have the same construction. In certain examples, the sealing module 300f can accommodate cables ranging in diameter from 0-18 millimeters.

The first and second sealant containment walls 101, 102 each include a reinforcing structure 107 and a sealant containment structure 108 that are secured together. The reinforcing structures 107 each include first and second reinforcing portions 109, 110 respectively corresponding to the first wall portions 101a, 102a and the second wall portions 101b, 102b of the first and second sealant containment walls 101, 102. The sealant containment structures 108 each include first and second sealant containment portions 111, 112 respectively corresponding to the first wall portions 101a, 102a and the second wall portions 101b, 102b of the first and second sealant containment walls 101, 102. The reinforcing structures 107 and the sealant containment structures 108 respectively have different first and second material compositions with the first material composition of the reinforcing structures 107 being harder than the second material composition of the sealant containment structures 108. The sealant containment structure 108 of the first sealant containment wall 101 is secured axially between the reinforcing structure 107 of the first sealant containment wall 101 and the sealant 38. The sealant containment structure 108 of the second sealant containment wall 102 is secured axially between the reinforcing structure 107 of the second sealant containment wall 102 and the sealant 38. The sealant 38 includes a third material composition that is softer than the second material composition.

In certain examples in accordance with the principles of the present disclosure, the sealant material 38 of the modules (e.g., gel) can have a hardness in the range of 10 to 60 Shore 000 and the material forming the sealant containment structures can have a hardness in the range of 10 to 40 Shore A. The sealant 38 (e.g., gel) is preferably softer than the material of the sealant containment structures 108. In certain examples in accordance with the principles of the present disclosure, the sealant 38 can have a hardness in the range of 10 to 60 Shore 000, or in the range of 5 to 25 Shore A, or in the range of 5 to 20 Shore A, or in the range of 5 to 15 Shore A, and material used for the sealant containment structures 108 can have a hardness in the range of 5 to 40 Shore A, or in the range of 5 to 30 Shore A, or in the range of 10 to 30 Shore A, or in the range of 20 to 30 Shore A. In certain examples, the reinforcing structures 107 of the modules can have a hardness greater than 50, 60, 70, or 80 Shore A.

In certain examples, the reinforcing structures 107 of at least the first and second sealant containment walls 101, 102 include latches 116 for latching the sealing module 300f between the inner and outer pressurization frames 306, 308 of the actuator arrangement of FIGS. 3 and 4. In certain examples, the first and second reinforcing portions 109, 110 of the reinforcing structures 107 include a snap-fit interface 117 for coupling the first and second bodies 103, 104 together 103, 104 by coupling the first wall portions 101a, 102a to the second wall portions 101b, 102b. In certain examples, the reinforcing structures 107 define a central guide structure 118 that aligns with a region between the cable pass-through locations for guiding assembly of the first and second bodies 103, 104 together. The central guide structure 118 includes a guide rail 119 on one of the first and second reinforcing portions 109, 110 that fits within a guide channel 120 on the other of the first and second reinforcing portions 109, 110. The relatively hard composition of the reinforcing structures 107 can be ideally suited for providing structures for latching and reinforcing.

In one example, the reinforcing structures 107 are co-molded with respect to their corresponding sealant containment structures 108. In the depicted example of FIGS. 34-45, the first material composition can include polyolefin, the second material composition can include silicone or thermoplastic elastomer, and the third material composition can include silicone gel or thermoplastic elastomer gel. Alternatively, the first material composition can include polyolefin, the second material composition can include polyolefin, and the third material composition can include silicone gel or thermoplastic elastomer gel. In such an example, while the first and second compositions may have the same base composition (e.g., a polyolefin such as polyethylene or polypropylene) which enhances bonding between the first and second material compositions during co-molding, the compositions can be modified with respect to each other such that the second material composition is softer than the first material composition. For example, in one embodiment, the first material composition can include a glass filling while the second material composition does not include glass filling or can include a lower amount of glass filling to provide a softer composition.

In certain examples, the sealing module 300f is configured to be able to accommodate a wide range of cable sizes (e.g., 0-18 millimeter cable diameter range) by having removeable inserts (e.g., sealant containers such as open-sided troughs) that can remain in the sealant 38 to allow the sealing module 300f to be compatible with smaller cables (i.e., cables having smaller diameters or cross-dimensions) and that can be torn from the sealant 38 to allow the sealing module 300f to be compatible with larger cables (i.e., cables having larger diameters or cross-dimensions). The first and second sealant portions 105, 106 can have first sides 121 that oppose each other when the sealing module 300f is assembled. One or more containers (e.g., open-sided troughs) can be provided in the sealing module 300f (e.g., in one or both of the first and second sealant portions 105, 106). As depicted, four containers are provided.

Referring to FIGS. 36 and 41, the sealing module 300f includes four open-sided troughs 122 embedded in the first and second sealant portions 105, 106 adjacent the first sides 121 (e.g., two at each of the first sides 121). The troughs 122 of the first sealant portion 105 oppose the troughs 122 of the second sealant portion 106. The open sides of the open-sided troughs 122 can face outwardly from the first sides 121 and toward each other. The open-sided troughs 122 can each have a trough length TL that extends at least 75 percent of a height h of the first and second sealant portions 105, 106. The open-sided troughs 122 are filled with sealant and are positioned to correspond to cable pass-through locations that extend through the height of the sealing module 300f. The open-sided troughs 122 each include opposite first and second longitudinal edges 124 (see FIG. 40) that extend along the trough length TL. For each of the troughs 122, the sealant portions 105, 106 have first and second rows of tear openings 125 at the first sides 121 which are positioned along the first and second longitudinal edges 124 for facilitating tearing the open-sided troughs 122 from the sealant portions 105, 106. The sealant portions 105, 106 define slits 127 that extends across a width of the open-sided troughs 122 adjacent ends of the first open-sided trough 122 to facilitate grasping the ends of the troughs 122 for tearing the troughs 122 from the first sides 121 of the sealant portions 105, 106.

The open-sided troughs 122 each include a central opening 129 for facilitating filling of the open-sided troughs 122 with sealant during insert molding the sealant portions 105, 106 about the troughs 122. The troughs 122 include cross-ribs 181 within the open-sided troughs 122 for facilitating positioning of the open-sided trough within the sealant portions 105, 106 during molding of the sealant portions 105, 106 about the troughs 122. The troughs 122 include longitudinal ribs 183 within the open-sided troughs 122 adjacent opposite ends of the open-sided troughs 122. The sealant portions 105, 106 define positioning openings 185 through the first sides 121 at locations between the first and second rows of tear openings 125. During molding of the sealant 38 about the troughs 122, positioning fingers in the molds hold the troughs 122 in place within the molds and define the positioning openings 185. The sealant portions 105, 106 each include second sides 133 positioned opposite from the first sides 121 (i.e., the second sides 133 face in opposite directions as compared to the first sides 121). The second sides 133 each define a plurality of volume compensation openings 135 for accommodating sealant during pressurization of the sealing module particularly when cables are present which displace the sealant during pressurization. In one example, the volume compensation openings 135 at each second side 133 cooperate to define an opening area that is at least 10, 15, 20 or 25 percent as large as a total area of each second side 133. In one example, the volume compensation openings 135 extend into the second sides 135 of the sealant portions 105, 106 along a dimension that is at least 10, 15 or 20 percent as large as the thickness t of each sealant portion 105, 106. In certain examples, the sealant 38 can be chamfered at outer edges along the depth d and the height h of the sealing module 300f (e.g., see chamfers 137, 138 at FIG. 34). In certain examples, the second sides 133 can include concave curvatures 140 that meet at a central peak 139 that extends along the height of the sealing module 300f (see FIG. 41).

In certain examples, the first and second sealant portions 105, 106 are bonded to their respective first and second sealant containment portions 111, 112. In certain examples, the first and second sealant portions 105, 106 fill face cavities 113 (see FIG. 39) defined by their corresponding first and second sealant containment portions 111, 112. In certain examples, the first and second sealant containment portions 111, 112 define ribs 114 within their corresponding face cavities 113 for enhancing bonding with their corresponding first and second sealant portions 105, 106. In certain examples, the first and second sealant containment portions 111, 112 each define at least one curved notch 115 that aligns with an axial cable pass-through location of the sealing module 300f that is defined between the first and second bodies 103, 104. In the depicted example of FIGS. 34-45, the first and second sealant containment portions 111, 112 each define two curved notches 115 (see FIGS. 38 and 39) that align with parallel axial cable pass-through locations (e.g., the locations of the opposing sets of troughs 122) of the sealing module 300f that are defined between the first and second bodies 103, 104. In the example of FIGS. 34-45, the curved notches 115 of the first and second sealant containment portions 111, 112 are defined by continuous sections 141 of the first and second sealant containment portions 111, 112. The curved notches 115 of the first and second sealant containment portions 111, 112 align with each other and cooperate to define cable openings that align with the cable pass-through locations. The continuous sections 141 of the first and second sealant containment portions 111, 112 have chamfered portions 143 that face away from the sealant 38 and extend along the boundaries of the shapes of the notches 115. Portions of the continuous sections 141 that face toward the sealant 38 are not chamfered. In one example, the shapes of the notches 115 do not have circular curvatures and are configured so that the resulting cable openings defined by paired notches 115 have elongate cross-sectional shapes including major cross-dimensions (e.g., the horizontal dimension at FIG. 37) and minor cross-dimensions (e.g., the vertical dimension at FIG. 37).

FIG. 46 depicts an alternative sealing module 300g (similar to the module 300f and usable as part of the cable sealing unit 30) which includes first and second sealant portions 1105, 1106 contained axially between first and second sealant containment walls 1101, 1102 each including a reinforcing structure 1107 and a sealant containment structure 1108. Similar to the sealing module 300f, the sealing module 300g includes first and second bodies that can be separated to allow one or more cables to be routed through the sealing module 300g between the first and second bodies. The reinforcing structures 1107 are preferably co-molded with and therefore bonded to the sealant containment structures 1108; but are shown separated from each other at FIG. 46 for explanation purposes. The reinforcing structures 1107 can be constructed of materials of the type described with respect to the reinforcing structures 107 and the sealant containment structures 1108 can be constructed of material of the type described with respect to the sealant containment structures 108. Hence, the reinforcing structures 1107 are constructed of a material with a material composition that is harder than a material composition of the sealant containment structures 1108. The sealant containment structures 1108 are between the reinforcing structures 1107 and the sealant portions 1105, 1106 and include continuous sections defining curved cable notches 1115. The sealant containment structures 1108 include more well-defined cavities 1113 for receiving, shaping and radially containing axial end portions 1199 of the first and second sealant portions 1105, 1106.

FIG. 47 depicts an alternative sealing module 300h (similar to the module 300f and usable as part of the cable sealing unit 30) which includes first and second sealant portions 2105, 2106 contained axially between first and second sealant containment walls 2101, 2102 each including a reinforcing structure 2107 and a sealant containment structure 2108. Similar to the sealing module 300f, the sealing module 300h includes first and second bodies that can be separated to allow one or more cables to be routed through the sealing module 300i between the first and second bodies. The reinforcing structures 2107 are preferably co-molded with and therefore bonded to the sealant containment structures 2108; but are shown separated from each other at FIG. 47 for explanation purposes. The reinforcing structures 2107 can be constructed of materials of the type described with respect to the reinforcing structures 107 and the sealant containment structures 2108 can be constructed of material of the type described with respect to the sealant containment structures 108. Hence, the reinforcing structures 2107 are constructed of a material with a material composition that is harder than a material composition of the sealant containment structures 2108. The sealant containment structures 2108 are between the reinforcing structures 2107 and the sealant portions 2105, 2106 and include sealant containment fingers 2197 defining curved cable notches 2115. The sealant containment fingers 2197 can be independently moveable and can have a cantilever-style configuration. As depicted, the sealant containment fingers 2197 are arranged in a truncated tapered (e.g., conical) configuration with base ends of the fingers 2197 at a major cross-dimension (e.g., a major diameter) of the truncated tapered configuration and free ends of the fingers 2197 at a minor cross-dimension of the truncated tapered configuration (e.g., a minor diameter). By using softer material for the sealant containment structures 2108, the fingers 2197 are less likely to damage the sealant 38. In a preferred example, the reinforcing structures 2107 and the sealant containment structures have a composition that includes polyolefin. The fingers 2197 are configured to flex in a radial orientation generally along their lengths with respect to their base ends.

FIG. 48 depicts an alternative sealing module 300i (similar to the module 300f and usable as part of the cable sealing unit 30) which includes first and second sealant portions 3105, 3106 contained axially between first and second sealant containment walls 3101, 3102 each including a reinforcing structure 3107 and a sealant containment structure 3108. Similar to the sealing module 300f, the sealing module 300i includes first and second bodies that can be separated to allow one or more cables to be routed through the module 300i between the first and second bodies. The reinforcing structures 3107 are preferably co-molded with and therefore bonded to the sealant containment structures 3108. The reinforcing structures 3107 can be constructed of materials of the type described with respect to the reinforcing structures 107 and the sealant containment structures 3108 can be constructed of material of the type described with respect to the sealant containment structures 108. Hence, the reinforcing structures 3107 are constructed of a material with a material composition that is harder than a material composition of the sealant containment structures 3108. The sealant containment structures 3108 are between the reinforcing structures 3107 and the sealant portions 3105, 3106. The sealant containment structures 3108 of the first and second sealant containment walls 3101, 3102 project radially outwardly beyond the sealant 38 (i.e., beyond the first and second sealant portions 3105; 3106) and radially outwardly beyond the reinforcing structures 3107 of the first and second containment walls 3101, 3102. For example, the sealant containment structures 3108 includes first radial projection portions 3191 and second radial projection portions 3192. The first radial projection portions 3191 project radially outwardly beyond the sealant 38 and the reinforcing structures 3107 of the first and second sealant containment walls 3101, 3102 along the length of the sealing module 300i. The second radial projection portions 3192 project radially outwardly beyond the sealant 38 and the reinforcing structures 3107 of the first and second sealant containment walls 3101, 3102 along the depth of the sealing module 300i. As depicted, the first and second redial projection portions 3191, 3192 cooperate to define radial projection structures 3193 at each of the first and second sealant containment walls 3101, 3102 that extend continuously about a perimeter of the sealing module 300i that includes the length and the depth of the sealing module. The radial projection structures 3193 project radially outwardly beyond the sealant 38 and the reinforcing structures 3107. The radial projection structures 3193 are separated by an axial gap g that traverses the sealant 38.

The radial projection structures 3193 assisting in protecting the gel and facilitating insertion of the cable sealing unit 30 into the opening 26 of the enclosure 20. For example, during insertion of the cable sealing unit 30 into the enclosure 20, the radial projection structures 3193 contact the interior of the housing 22 rather than the sealant which makes the cable sealant unit 30 easier to insert and prevents sealant shearing by preventing sticking of the sealant 38 (which tends to be tackier than the radial projection structures 3193) to the interior of the housing 22 during the insertion process. The insertion step is shown schematically at FIGS. 49 and 50. Once the cable sealing unit 30 has been inserted in the opening and prior to pressurization of the sealant 38, the radial projection structures 3193 corresponding to the first and second sealant containment walls 3101, 3102 (i.e., the inner and outer sealant containment walls) form inner and outer radial seals 25, 27 with an interior surface 23 of the housing 22 which defines the opening 26. The radial seals 25, 27 extend fully about the perimeter of the sealing unit 30 and a respectively located adjacent the inner and outer pressurization frame 306, 308. The sealant 38 (i.e., the first and second sealant portions 3105, 3106) is captured/contained axially between the inner and outer radial seals 25, 27. When the sealing unit 30 is actuated and the sealant 38 is pressurized between the inner and outer pressurization structures 42, 44, the sealant 38 deforms radially outwardly to seal against the interior surface 23 (see FIG. 51). As the sealant deforms, the inner and outer seals 25, 27 assist in maintaining containment of the sealant 38 between the inner and outer pressurization structures 42, 44 and prevent the sealant 38 from extruding axially between the interior surface 23 and the inner and outer pressurization structures 42, 44 which assist sin preventing shearing of the sealant 38.

FIGS. 52-63 depict an alternative sealing module 300j (similar to the module 300f and usable as part of the cable sealing unit 30) which includes first and second sealant portions 4105, 4106 of the sealant 38 contained axially between first and second sealant containment walls 4101, 4102. Similar to the sealing module 300f, the sealing module 300j includes first and second bodies 4103, 4104 that can be separated to allow one or more cables to be routed through the module 300j between the first and second bodies 4103, 4104. The first body 4103 includes first wall portions 4101a, 4102a of the first and second sealant containment walls 4101, 4102 and the first sealant portion 4105. The first sealant portion 4105 is secured axially between the first wall portions 4101a, 4102b. The second body 4104 includes second wall portions 4101b, 4102b of the first and second sealant containment walls 4101, 4102 and the second sealant portion 4106 of the sealant 38. The depicted example is adapted for sealing about flat cables such as flat drop cables. As depicted, the sealing module 300j can accommodate up to 8 flat drop cables. The sealant 38 can define cable pass-through openings 4188 that pass through the height of the module 300j and define cable pass-through locations of the module 300j. The cable pass-through openings 4188 can be parallel. In one example, the cable pass-through openings can have elongate cross-sectional shapes that correspond to the elongate cross-sectional shape of the outer profile of a jacket of a flat drop cable. The openings 4188 can be filled with plugs when not occupied by cables.

The first and second sealant containment walls 4101, 4102 define cable openings 4187 corresponding to the cable pass-through openings 4188 defined though the sealing module 300j. The first and second sealant containment walls 4101, 4102 include pairs of first and second fins 4190 corresponding to at least some of the cable pass-through openings 4188. The first and second fins 4190 have base ends unitary with the sealant containment walls 4101, 4102 and free ends embedded in the sealant 38. The first and second fins 4190 of each pair converge as the first and second fins 4190 extend into the sealant 38. The first and second fins 4190 are adapted for providing sealant containment when sealing a flat cable and are adapted to oppose major sides of the flat cable when the cable is routed through the sealing module 300j. In the depicted example, each of the cable openings 4187 does not include more than two of the fins 4190. The first and second fins 4190 are configured to resiliently flex apart to accommodate a cable between the first and second fins 4190 when the cable is routed through a corresponding one of the cable pass-through location.

A cable locator 4192 projects outwardly from one of the sealant containment walls 4101, 4102 (e.g., the outer sealant containment wall 4101) and defines cable pockets 4193 that align with cable pass-through locations of the sealing module 300j. In one example, the cable locator 4192 is unitarily formed with the sealant containment wall 4101 and the cable pockets 4193 are sized for receiving flat cables. In one example, the cable pockets 4193 are arranged in pair with each pair of cable pockets 4193 sharing a common cable insertion opening 4194 (e.g., gaps for allowing vertical insertion of cables into the pockets). The cable insertion openings 4194 of the pairs of cable pockets 4193 align with dividers 4196 between the cable pockets 4193 of each pair of cable pockets 4193. It will be appreciated that the first and second sealant containment walls 4101, 4102 have basically the same construction except the second sealant containment wall 4102 lacks the cable locator 4192 (see FIGS. 60-63).

FIGS. 64-71 depict an alternative sealing module 300k (similar to the module 300f and usable as part of the cable sealing unit 30) which includes first and second sealant portions 5105, 5106 of the sealant 38 contained axially between first and second sealant containment walls 5101, 5102. Similar to the sealing module 300f, the sealing module 300k includes first and second bodies 5103, 5104 that can be separated to allow one or more cables to be routed through the module 300k between the first and second bodies 5103, 5104. The first body 5103 includes first wall portions 5101a, 5102a of the first and second sealant containment walls 5101, 5102 and the first sealant portion 5105. The first sealant portion 5105 is secured axially between the first wall portions 5101a, 5102b. The second body 5104 includes second wall portions 5101b, 5102b of the first and second sealant containment walls 5101, 5102 and the second sealant portion 5106 of the sealant 38. The first wall portions 5101a, 5102a and the second wall portions 5101b, 5102b each define at least one curved notch 5115 that aligns with an axial cable pass-through location of the sealing module 300j that is defined between the first and second bodies 5103, 5104. The curved notches 5115 of the first wall portions 5101a, 5102a and the second wall portions 5101b, 5102b are defined by sealant containment fingers 5197 that extend into the sealant 38. The fingers 5197 are resilient cantilevers and include base ends and free ends. The fingers 5197 are configured to flex in a radial orientation generally along their lengths with respect to their base ends. The fingers 5197 are depicted arranged in a truncated, tapered configurations 5183 (e.g., truncated conical configurations). Tips at the free ends of the fingers 5197 define a minor inner cross-dimension (e.g., a minor inner diameter) of the tapered structure and the base ends define a major inner cross-dimension (e.g., a major inner diameter) of the tapered structure. The sealant 38 defines a pass-through opening 5189 that extends along the cable-pass-through location. The sealant 38 is stepped (see step 5179 at FIG. 71) outwardly adjacent the tips of the sealant containment fingers 5197 such that a cross-dimension (e.g., an inner diameter) defined by the pass-through opening 5189 is larger than the minor inner cross-dimension defined by the tips of the fingers 5197. As depicted, the sealing module 300j includes two parallel cable pass-through locations with the tapered structures defined by the fingers 5197 located at opposite ends of each cable pass-through location. In one example, the sealing module 300j can accommodate cables ranging in diameter from 18-23 millimeters.

In the depicted example, the cable-pass-through locations are defined by the passages/openings 5189 that extend through the height of the sealant 38. When the passages/openings 5189 are not occupied by cables, the passages/openings can be filled by plugs 5185 (e.g., dummy rods). In certain examples, the openings defined by the sets of fingers 5197 can be elongate in cross-sectional shape (e.g., oval, obround, race-track-shaped). In the depicted example, notches 5115 defined by the first wall portions 5101a, 5102a have a different (e.g., non-asymmetric) but mating/complementary shape with respect to the notches 5115 of the second wall portions 5101b, 5102b. For example, the notches 5115 defined by the first wall portions 5101a, 5102a have fewer fingers 5197 than the notches 5115 of the second wall portions 5101b, 5102b. When the first and second bodies 5103, 5104 are coupled together, the notches 5115 of the first wall portions 5101a, 5102a cooperate with the notches 5115 of the second wall portions 5101b, 5102b to form the tapered, truncated configurations 5183. When the first and second bodies 5103, 5104 are coupled together, a majority of the fingers 5197 of the second wall portions 5101b, 5102b are positioned on one side of a reference plane RP (shown as a horizontal plane at FIG. 67) that bisects of each of the cable pass-through locations, but at least one of the fingers 5197 is positioned on an opposite second side of the reference plane RP.

As used herein, de-pressurize means to reduce the pressure and pressurize means to increase the pressure.

It will be appreciated that a variety of different material types can be used as a sealant. Example materials include elastomers, including natural or synthetic rubbers. In still other embodiments, the sealant comprise gel and/or gel combined with another material such as an elastomer. The gel may, for example, comprise silicone gel, urea gel, urethane gel, thermoplastic elastomeric gel, or any suitable gel or geloid sealing material. Gels are normally substantially incompressible when placed under a compressive force and normally flow and conform to their surroundings thereby forming sealed contact with other surfaces. Example gels include oil-extended polymers. The polymer may, for example, comprise an elastomer, or a block copolymer having relatively hard blocks and relatively elastomeric blocks. Example copolymers include styrene-butadiene or styrene-isoprene di-block or tri-block copolymers. In still other embodiments, the polymer of the gel may include one or more styrene-ethylene-propylene-styrene block copolymers. Example extender oils used in example gels may, for example, be hydrocarbon oils (e.g., paraffinic or naphthenic oils or polypropene oils, or mixtures thereof).

As used herein, an axial dimension of a cable sealing module corresponds to (e.g., is parallel to) the direction of an axis of a cable as it extends through the cable sealing module.

In certain examples, the sealant material (e.g., gel) can each have an elastomeric construction with a base composition that includes silicone (e.g., polysiloxanes or polymethylsiloxanes). In certain examples, the sealant material can each include an elastomeric construction with a base composition that includes a thermoplastic elastomer. Example thermoplastic elastomers can include styrenic block copolymers, thermoplastic polyurethanes, thermoplastic copolyesters, thermoplastic polyamides, thermoplastic polyolefin elastomers, and other thermoplastic elastomers. Example sealing gels can include gels (e.g., silicone gels and other gels) of the type disclosed at PCT International Publication Number WO 2021/113109, which is hereby incorporated by reference in its entirety.

### EXAMPLE ASPECTS

Aspect 1. A cable sealing device comprising:
a sealing module including sealant contained between sealant containment walls, the sealing module including first and second bodies that join together to form the cable sealing module and that are separable to facilitate routing a cable between the first and second bodies, the first body includes first wall portions of the sealant containment walls and a first sealant portion of the sealant, the first sealant portion being secured axially between the first wall portions, the second body including second wall portions of the sealant containment walls and a second sealant portion of the sealant, the second sealant portion being secured axially between the second wall portions, the first and second wall portions meeting at a mechanical interface having discrete overlap locations.

Aspect 2. The cable sealing device of Aspect 1, wherein the containment walls are elongate along a length that extends between opposite ends, and wherein the discrete overlap locations are located at a central region along the length and at the opposite ends.

Aspect 3. The cable sealing device of Aspect 1, wherein at least one of the containment walls includes a threaded fastener that extends in an axial direction and that couples the first and second wall portions together.

Aspect 4. The cable sealing device of Aspect 1, wherein the first and second cable pass-through locations are defined side-by-side in the cable sealing module, wherein each cable pass-through location can accommodate only one cable, and wherein the first cable pass-through location can accommodate a cable having a diameter that is at least 2.5 times as large as the largest diameter cable that can be accommodated by the second cable pass-through location.

Aspect 5. The cable sealing device of Aspect 4, wherein the first and second cable pass-through locations are the only cable pass-through locations of the sealing module.

Aspect 6. A cable sealing device comprising:
a sealing module including sealant contained between sealant containment walls, the sealing module including first and second bodies that join together to form the cable sealing module and that are separable to facilitate routing a cable between the first and second bodies, the first body includes first wall portions of the sealant containment walls and a first sealant portion of the sealant, the first sealant portion being secured axially between the first wall portions, the second body including second wall portions of the sealant containment walls and a second sealant portion of the sealant, the second sealant portion being secured axially between the second wall portions, the first and second sealant portions each including first and second removeable sealing portions that are removeable from a primary sealant portion, the first removeable sealant portion being carried by an elongate removeable container that extends along a cable-pass-through orientation of the sealing module and that can be torn from the primary sealant portion, the second removeable sealant portion extending transversely relative to the cable pass-through orientation outside a boundary defined by the removeable container.

Aspect 7. A cable sealing device comprising:
a sealing module including sealant contained between sealant containment walls, the sealing module including first and second bodies that join together to form the cable sealing module and that are separable to facilitate routing a cable between the first and second bodies, the first body includes first wall portions of the sealant containment walls and a first sealant portion of the sealant, the first sealant portion being secured axially between the first wall portions, the second body including second wall portions of the sealant containment walls and a second sealant portion of the sealant, the sealing module including sealant containment sheet coupled to each of the first and second wall portions, the seal sealant containment having resilient constructions and including rails that fit within channels defined by the first and second wall portions.

Aspect 8. A cable sealing device comprising:
a sealing module including sealant contained between sealant containment walls, the sealing module including first and second bodies that join together to form the cable sealing module and that are separable to facilitate routing a cable between the first and second bodies, the first body includes first wall portions of the sealant containment walls and a first sealant portion of the sealant, the first sealant portion being secured axially between the first wall portions, the second body including second wall portions of the sealant containment walls and a second sealant portion of the sealant, the sealing module including at least one sealant containment device coupled to at least one of the sealant containment walls, the sealant containment device including a base strip and a plurality of clips spaced along the base strip, each of the clips including a pair of first and second resilient clip arms coupled to the base strip, wherein each clip corresponds to a cable pass-through location and wherein the clips are adapted to receive cables between the first and second clip arms.

Aspect 9. The cable sealing device of Aspect 8, wherein the first clip arms are aligned along a first plane and the second clip arms are aligned along a second plane parallel to and spaced from the first plane.

Aspect 10. The cable sealing device of Aspect 8, wherein the first and second clip arms have different lengths.

Aspect 11. A cable sealing device comprising:
a sealing module including sealant contained between sealant containment walls, the sealing module including first, second and third bodies that join together to form the cable sealing module and that are separable to facilitate routing a cable between the first and second bodies, the first body includes first wall portions of the sealant containment walls and a first sealant portion of the sealant, the first sealant portion being secured axially between the first wall portions, the second body including second wall portions of the sealant containment walls and a second sealant portion of the sealant, the third body mounting between the first and second bodies and including third wall portions of the sealant containment walls a third portion of the sealant, the third sealant portion being secured axially between the third wall portions, wherein first cable pass-through locations are defined between the first and third sealant portions and second cable pass-through locations are defined between the third and second sealing portions, wherein the sealing module includes a sealant containment configuration including linear comb structures, the linear comb structures including first linear comb structures formed with the first wall portions, second linear comb structures formed with the second wall portions, third linear comb structures formed with the third wall portions adjacent the first linear comb structures to form first comb pairs at the first cable pass-through location, and fourth linear comb structures formed with the third wall portions adjacent the second linear comb structures to form second comb pairs at the second cable pass-through location, wherein comb fingers of each linear comb structure have a resilient construction and are configured to flex apart to accommodate cables passed through the cable pass-through locations.

Aspect 12. The cable sealing device of Aspect 11, wherein the first and second cable pass-through locations do not define discrete cable ports, and wherein cable openings corresponding to specific cable pass-through positions at the cable pass-through locations are defined by the containment walls via the cooperation of the first, second and third wall portions.

1. A cable sealing device comprising:
a sealing module including sealant contained axially between first and second sealant containment walls, the sealing module including first and second bodies that join together to form the cable sealing module and that are separable to facilitate routing a cable between the first and second bodies, the first body including first wall portions of the first and second sealant containment walls and a first sealant portion of the sealant, the first sealant portion being secured axially between the first wall portions, the second body including second wall portions of the first and second sealant containment walls and a second sealant portion of the sealant, the second sealant portion being secured axially between the second wall portions, the first and second sealant containment walls each include a reinforcing structure and a sealant containment structure that are secured axially together, the reinforcing structures each include first reinforcing portions corresponding to the first wall portions and second reinforcing portions corresponding the second wall portions, the sealant containment structures each include first sealant containment portions corresponding to the first wall portions and second sealant containment portions corresponding to the second wall portions, the reinforcing structure and the sealant containment structure respectively having different first and second material compositions with the first material composition of the reinforcing structures being harder than the second material composition of the sealant containment structures, the sealant containment structures being secured axially between the sealant and the reinforcing structures of the first and second containment walls, and wherein the sealant includes a third material composition that is softer than the second material composition.

2. The cable sealing device of claim 1, wherein the first and second sealant portions are bonded to their corresponding first and second sealant containment portions.

3. The cable sealing device of claim 2, wherein the first and second sealant portions fill face cavities defined by their corresponding first and second sealant containment portions.

4. The cable sealing device of claim 3, wherein the first and second sealant containment portions define ribs within their corresponding face cavities that embed into the sealant for enhancing bonding with their corresponding first and second sealant portions.

5. The cable sealing device of claim 1, wherein the first and second sealant containment portions each define at least one curved notch that aligns with an axial cable pass-through location of the sealing module that is defined between the first and second bodies.

6. The cable sealing device of claim 5, wherein the curved notches of the first and second sealant containment portions are defined by continuous sections of the first and second sealant containment portions.

7. The cable sealing device of claim 5, wherein the curved notches of the sealant first and second containment portions are defined by sealant containment fingers.

8. The cable sealing device of claim 1, wherein the reinforcing structures the first and second sealant containment walls include latches for latching the sealing module between inner and outer pressurization frames of an actuator.

9. The cable sealing device of claim 1, wherein the reinforcing structures of the first and second sealant containment walls include a snap-fit interfaces for coupling the first and second bodies together.

10. The cable sealing device of claim 1, wherein the first and second sealant containment portions each define two curved notches that align with parallel axial cable pass-through locations of the sealing module that are defined between the first and second bodies, and wherein the reinforcing structures of the first and second sealant containment walls define a central guide structure that aligns with a region between the cable pass-through locations for guiding assembly of the first and second bodies together, wherein the central guide structure includes a guide rail that fits within a guide channel.

11. The cable sealing device of claim 1, wherein the reinforcing structures are co-molded with respect to their corresponding sealant containment structures.

12. The cable sealing device of claim 11, wherein the first material composition includes polyolefin, wherein the second material composition includes silicone or thermoplastic elastomer, and wherein the third material composition includes silicone gel or thermoplastic elastomer gel.

13. The cable sealing device of claim 11, wherein the first material composition includes polyolefin, wherein the second material composition includes polyolefin, and wherein the third material composition includes silicone gel or thermoplastic elastomer gel.

14. The cable sealing device of claim 13, wherein the first material composition includes glass filling and the second material composition does not include glass filling.

15. The cable sealing device of claim 1, wherein the sealant containment structures project radially outwardly beyond the sealant and the reinforcing structures.

16. The cable sealing device of claim 15, wherein the sealant containment structures of each of the first and second sealant containment walls include first radial projection portions that project radially outwardly beyond the sealant and the reinforcing structures of the first and second sealant containment walls along a length of the sealing module, and wherein the sealant containment structures of each of the first and second sealant containment walls include second radial projection portions that project radially outwardly beyond the sealant and the reinforcing structures of the first and second sealant containment walls along a depth of the sealing module.

17. The cable sealing device of claim 16, wherein the first and second radial projections at each of the first and second sealant containment walls cooperate to define radial seal structures extend continuously about a perimeter of the sealing module, the perimeter of the sealing module extending along the length and the depth of the sealing module.

18. A cable sealing device comprising:
a sealing module including sealant contained axially between sealant containment walls, the sealing module including first and second bodies that join together to form the cable sealing module and that are separable to facilitate routing a cable between the first and second bodies, the first body including first wall portions of the sealant containment walls and a first sealant portion of the sealant, the first sealant portion being secured axially between the first wall portions, the second body including second wall portions of the sealant containment walls and a second sealant portion of the sealant, the second sealant portion being secured axially between the second wall portions, the first and second wall portions defining a central guide structure that aligns with a region between two cable pass-through locations of the sealing module for guiding assembly of the first and second bodies together, wherein the central guide structure includes a guide rail that fits within a guide channel.

19. The cable sealing device of any of claim 18, wherein the first and second wall portions include snap-fit interfaces for coupling the first and second bodies together, the sealing module having a module length that is transverse relative to a direction of extension of the axial cable pass-through locations, and wherein the snap-fit interfaces are at opposite ends of the module length.

20. A cable sealing device comprising:
a sealing module including sealant axially contained between sealant containment walls, the sealing module including first and second bodies that join together to form the cable sealing module and that are separable to facilitate routing a cable between the first and second bodies, the first body including first wall portions of the sealant containment walls and a first sealant portion of the sealant, the first sealant portion being secured axially between the first wall portions, the second body including second wall portions of the sealant containment walls and a second sealant portion of the sealant, the second sealant portion being secured axially between the second wall portions, the first and second sealant portions having first sides that oppose each other when the sealing module is assembled, the sealing module including a first open-sided trough embedded in the first sealant portion adjacent the first side, the first open-sided trough having a trough length that extends at least 75 percent of a height of the first sealant portion, the first open-sided trough being filled with sealant and being positioned to correspond to a cable pass-through location that extends through the height of the sealing module, the first open-sided trough including opposite first and second longitudinal edges that extend along the trough length, the first sealant portion having first and second rows of tear openings at the first side which are positioned along the first and second longitudinal edges for facilitating tearing the open-sided trough from the first sealant portion.

21. The cable sealing device of claim 20, wherein a second open-sided trough is embedded in the second sealant portion adjacent the first side of the second sealant portion, the second open-sided trough being positioned to align with the first open-sided trough when the sealing module is assembled.

22. The cable sealing device of claim 20, wherein the first sealant portion defines slits that extends across a width of the first open-sided trough adjacent ends of the first open-sided trough to facilitate tearing.

23. The cable sealing device of claim 20, wherein the first open-sided trough includes a central opening for facilitating filling of the first open-sided trough with sealant during molding of the first sealant portion, cross-ribs within the first open-sided trough for facilitating positioning of the first open-sided trough within the first sealant portion during molding of the first sealant portion, and longitudinal ribs within the first open-sided trough adjacent ends of the first open-sided trough.

24. The cable sealing device of claim 20, wherein the first sealant portion defines positioning openings through the first side at locations between the first and second rows of tear openings.

25. The cable sealing device of claim 20, wherein the first sealant portion has a second side positioned opposite from the first side, and wherein the second side defined a plurality of volume compensation openings for accommodating sealant during pressurization of the sealing module.

26. A cable sealing device comprising:
a sealing module including sealant axially contained between sealant containment walls, the sealing module including first and second bodies that join together to form the cable sealing module and that are separable to facilitate routing a cable between the first and second bodies, the first body including first wall portions of the sealant containment walls and a first sealant portion of the sealant, the first sealant portion being secured axially between the first wall portions, the second body including second wall portions of the sealant containment walls and a second sealant portion of the sealant, the second sealant portion being secured axially between the second wall portions, wherein the first and second wall portions each define at least one curved notch that aligns with an axial cable pass-through location of the sealing module that is defined between the first and second bodies, wherein the curved notches of the first and second wall portions are defined by sealant containment fingers that extend into the sealant and form a truncated, tapered structure, wherein tips of the sealant containment fingers define a first inner cross-dimension, wherein the sealant defines a pass-through opening that extends along the cable-pass-through location, and wherein the sealant is stepped adjacent the tips of the sealant containment fingers such that a second inner cross-dimension defined by the pass-through opening is larger than the first inner cross-dimension.

27. The cable sealing device of claim 26, wherein the curved notches of the first and second wall portions are asymmetric and complementary.

28. A cable sealing device comprising:
a sealing module including sealant axially contained between sealant containment walls, the sealing module including first and second bodies that join together to form the cable sealing module and that are separable to facilitate routing a cable between the first and second bodies, the first body including first wall portions of the sealant containment walls and a first sealant portion of the sealant, the first sealant portion being secured axially between the first wall portions, the second body including second wall portions of the sealant containment walls and a second sealant portion of the sealant, the second sealant portion being secured axially between the second wall portions, further comprising a cable locator that projects outwardly from one of the sealant containment walls and defines cable pockets that align with cable pass-through locations of the sealing module.

29. The cable sealing device of claim 28, wherein the cable locator is unitarily formed with the sealant containment wall and the cable pockets are sized for receiving flat cables.

30. The cable sealing device of claim 29, wherein the cable pockets are arranged in pairs, wherein each pair of cable pockets shares a common cable insertion opening, and wherein the cable insertion openings of the pairs of cable pockets align with dividers between the cable pockets of each pair of cable pockets.

31. A cable sealing device comprising:
a sealing module including sealant axially contained between sealant containment walls, the sealing module including first and second bodies that join together to form the cable sealing module and that are separable to facilitate routing a cable between the first and second bodies, the first body including first wall portions of the sealant containment walls and a first sealant portion of the sealant, the first sealant portion being secured axially between the first wall portions, the second body including second wall portions of the sealant containment walls and a second sealant portion of the sealant, the second sealant portion being secured axially between the second wall portions, wherein the sealant containment walls define cable openings corresponding to cable pass-through locations defined though the sealing module, wherein the sealant containment walls include pairs of first and second fins corresponding to at least some of the cable pass-through locations, wherein the first and second fins have base ends unitary with the sealant containment walls and free ends embedded in the sealant, wherein the first and second fins of each pair converge as the first and second fins extend into the sealant, and wherein the first and second fins are adapted for providing sealant containment when sealing a flat cable and are adapted to oppose major sides of the flat cable when the cable is routed through the sealing module, wherein each of the cable openings does not include more than two of the fins, and wherein the first and second fins of each pair of first sand second fins are configured to resiliently flex apart to accommodate a cable between the first and second fins when the cable is routed through a corresponding one of the cable pass-through locations.

32. An enclosure comprising:
a housing defining an opening; and
a cable sealing unit that fits in the opening of the housing, the cable sealing unit including sealing gel positioned between inner and outer pressurization structures of an actuator configured for pressurizing the sealing gel between the inner and outer pressurization structures once the cable sealing unit has been inserted in the housing, wherein the housing has an interior surface defining the opening, wherein the sealing gel seals against the interior surface when the sealing gel is pressurized between the inner and outer pressurization structure while the cable sealing unit is located within the opening of the housing, wherein the cable sealing unit includes radial seal structures at the inner and outer pressurization structures that project radially outwardly further than the sealing gel prior to pressurization of the sealing gel, wherein the radial seal structures are elastomeric and form inner and outer radial seals with respect to the interior surface of the housing when the cable sealing unit is initially inserted into the opening and prior to pressurization of the sealing gel, wherein the sealing gel is contained between the inner and outer radial seals when the sealing gel is pressurized between the inner and outer pressurizations structures while the cable sealing unit is within the opening of the housing, and wherein the radial seal structures have a material composition that is harder than a material composition of the sealing gel.
